(19) United States
(12) Patent Application Publication
(10) Pub. No.: US 2019/0055432 A1
(43) Pub. Date: Feb. 21, 2019

(54) CURING TYPE ADHESIVE COMPOSITION FOR POLARIZING FILM AND MANUFACTURING METHOD THEREFOR, POLARIZING FILM AND MANUFACTURING METHOD THEREFOR, OPTICAL FILM AND IMAGE DISPLAY DEVICE

(71) Applicant: NITTO DENKO CORPORATION, Ibaraki-shi, Osaka (JP)

(72) Inventors: Ryo Kanno, Ibaraki-shi (JP); Tatsuya Yamasaki, Ibaraki-shi (JP); Yuto Saruhashi, Ibaraki-shi (JP); Ryuta Tomoyose, Ibaraki-shi (JP); Takeshi Saito, Ibaraki-shi (JP); Tetsuro Ikeda, Ibaraki-shi (JP)

(73) Assignee: NITTO DENKO CORPORATION, Ibaraki-shi, Osaka (JP)

(21) Appl. No.: 15/764,115

(22) PCT Filed: Sep. 29, 2016
(86) PCT No.: PCT/JP2016/078889

§ 371 Date: Mar. 28, 2018

(30) Foreign Application Priority Data
Oct. 2, 2015 (JP) 2015-196962
Sep. 26, 2016 (JP) 2016-187165

(51) Int. Cl. C09J 4/00; B32B 7/12; B32B 37/12; B32B 37/18; B32B 27/08; B32B 27/30; B32B 38/00; C09J 135/02; C09J 5/00; C08F 222/10

(52) U.S. Cl. CPC C09J 4/00; G02B 1/14; B32B 37/12; B32B 37/182; B32B 27/08; B32B 27/306; B32B 38/0008; C09J 135/02; C09J 5/00; C08F 222/1006; B32B 2255/10; B32B 2255/26; B32B 2305/72; B32B 2307/42; B32B 2310/0806; B32B 2329/04; B32B 2457/20; B32B 2551/00; C09J 2205/31; C09J 2433/00; C08F 2222/108; B32B 7/12

(57) ABSTRACT

A curing type adhesive composition for polarization film, contains an active energy ray curable component (X), at least one organometallic compound (A) selected from the group consisting of a metal alkoxide and a metal chelate, and a polymerizable compound (B) having a polymerizable functional group and a carboxyl group. It is preferred that a metal of the organometallic compound (A) is titanium. The curing type adhesive composition for polarizing film preferably contains, as the organometallic compound (A), the metal alkoxide, and an organic group which the metal alkoxide has having three or more carbon atoms. The curing type adhesive composition for polarizing film contains, as the organometallic compound (A), the metal chelate, an organic group which the metal chelate has having four or more carbon atoms.

### TECHNICAL FIELD

The present invention relates to a curing type adhesive composition, for polarizing film, that forms an adhesive layer in a polarizing film in which a polarizer and a transparent protective film are laminated over each other to interpose this adhesive layer. The invention also relates to a polarizing film in which the adhesive layer is used. The polarizing film can form, alone or in the form of an optical film over which this polarizing film is laminated, an image display device such as a liquid crystal display device (LCD), an organic EL display device, a CRT or a PDP.

### BACKGROUND ART

For watches, portable telephones, PDAs, notebook personal computers, monitors for personal computers, DVD players, TVs and others, liquid crystal display devices have been rapidly developed into the market. Liquid crystal display devices are devices in each of which in accordance with the switching of a liquid crystal, the polarization state thereof is made visual. On the basis of a display principle thereof, a polarizer is used. In particular, TVs and other articles have been increasingly required to be made higher in brightness and contrast, and wider in visual field angle. Their polarizing film has also been increasingly required to be made higher in transmittance, polarization degree, color reproducibility and others.

As the polarizer, an iodine-based polarizer is most generally and widely used, which has a structure in which iodine has been adsorbed onto, for example, polyvinyl alcohol (hereinafter referred to merely as “PVA”) and the resultant has been drawn since this polarizer is high in transmittance and polarization degree. A generally used polarizing film is a film in which transparent protective films are bonded, respectively, onto both surfaces of a polarizer through the so-called water-based adhesive, in which a polyvinyl alcohol-based material is dissolved in water (Patent Document 1 listed below). For the transparent protective films, for example, triacetylcellulose is used, which is high in moisture permeability. In the case of using the water-based adhesive (the so-called wet lamination), a drying step is required after the transparent protective films are bonded to the polarizer.

Instead of the water-based adhesive, an active energy ray curing type adhesive is suggested. When the active energy ray curing type adhesive is used to produce polarizing films, no drying step is required. Thus, the polarizing films can be improved in producibility. Suggested is, for example, a radical-polymerizing-type active energy ray curing type adhesive composition in which an N-substituted amide type monomer is used as a curable component (Patent Document 2 listed below). This adhesive composition exhibits an excellent endurance in a severe environment at high humidity and high temperature. However, in the actual situation, the market is requesting an adhesive composition about which adhesive performance and/or water resistance can be improved.

### PRIOR ART DOCUMENTS

### Patent Documents

Patent Document 1: JP-A-2006-220732

Patent Document 2: JP-A-2008-287207

### SUMMARY OF THE INVENTION

### Problems to be Solved by the Invention

The inventors have made eager investigations about the development of adhesive compositions which can improve the resultant adhesive layer in adhesive performance and water resistance to gain a conclusion that a reciprocal relationship lies between the improvement of the adhesive layer in adhesive performance and water resistance, and the liquid stability of the composition, which is a raw material of the layer, and a further contrivance is requited for solving these two. The inventors have found out that in order to solve this problem, it is very useful to combine a specified organometallic compound with a specified polymerizable compound.

In the light of this actual situation, the present invention has been developed, and an object thereof is to provide a curing type adhesive composition, for polarizing film, that can form an adhesive layer which is good in adhesion onto a polarizer and a transparent protective film and which is excellent in water resistance even under severe conditions in, for example, a dew condensation environment, and that is excellent in liquid stability, long in pot life and also excellent in producibility.

Another object of the present invention is to provide a polarizing film in which a transparent protective film is fitted to a polarizer through an adhesive layer formed using a curing type adhesive composition for polarizing film; an optical film in which the polarizing film is used; and an image display device in which the polarizing film or the optical film is used.

### Means for Solving the Problems

In order to solve the above-mentioned problem, the inventors have repeatedly made eager investigations to find out that the objects can be attained by a curing type adhesive composition described below for polarizing film.

Accordingly, the present invention relates to a curing type adhesive composition for polarizing film, comprising an active energy ray curable component (X), at least one organometallic compound (A) selected from the group consisting of a metal alkoxide and a metal chelate, and a polymerizable compound (B) having a polymerizable functional group and a carboxyl group.

In the curing type adhesive composition for polarizing film, it is preferred that a metal of the organometallic compound (A) is titanium.

It is preferred that the curing type adhesive composition for polarizing film comprises, as the organometallic compound (A), the metal alkoxide, and an organic group which the metal alkoxide has three or more carbon atoms.

It is preferred that the curing type adhesive composition for polarizing film comprises, as the organometallic compound (A), the metal chelate, and an organic group which the metal chelate has four or more carbon atoms.

In the curing type adhesive composition for polarizing film, it is preferred that the proportion of the organometallic compound (A) is from 0.05 to 15% by weight of the whole of the curing type adhesive composition for polarizing film.

In the curing type adhesive composition for polarizing film, it is preferred that the polymerizable compound (B) has a molecular weight of 100 (g/mol) or more.

In the curing type adhesive composition for polarizing film, it is preferred that the polymerizable compound (B) is a polymerizable compound having a polymerizable functional group and a carboxyl group to interpose, between the groups, an organic group which has 1 to 20 carbon atoms and may contain oxygen.

In the curing type adhesive composition for polarizing film, it is preferred that when the total amount of the organometallic compound (A) in the curing type adhesive composition for polarizing film is represented by α (mol), the content of the polymerizable compound (B) in the composition is 0.25α (mol) or more.

In the curing type adhesive composition for polarizing film, it is preferred that in the case of immersing a cured product yielded by curing the curing type adhesive composition for polarizing film in pure water of 23° C. temperature for 24 hours, the cured product shows a bulk water absorption of 10% or less by weight, the bulk water absorption being represented by the following expression:

{(M2−M1)/M1}×100(%)

wherein M1: the weight of the cured product before the immersion, and M2: the weight of the cured product after the immersion.

In the curing type adhesive composition for polarizing film, it is preferred that the active energy ray curable component (X) comprises a radical polymerizable compound.

In the curing type adhesive composition for polarizing film, it is preferred that the radical polymerizable compound comprises a (meth)acrylamide derivative.

In the curing type adhesive composition for polarizing film, it is preferred that the radical polymerizable compound comprises a polyfunctional compound having at least two functional groups having radical polymerizability.

It is preferred that the curing type adhesive composition for polarizing film further comprises a photopolymerization initiator.

It is preferred that the curing type adhesive composition for polarizing film further comprises a compound having a vinyl ether group.

It is preferred that the curing type adhesive composition for polarizing film further comprises an optical acid-generator.

In the curing type adhesive composition for polarizing film, it is preferred that the cured product yielded by curing the curing type adhesive composition for polarizing film has a storage modulus of 1.0×10⁷ Pa or more at 25° C.

The present invention also relates to a method for manufacturing the curing type adhesive composition recited in any one of the paragraphs concerned for polarizing film, the method comprising a first mixing step of mixing the active energy ray curable component (X) with the polymerizable compound (B), which has the polymerizable functional group and the carboxyl group, to yield a mixed curable component, and a second mixing step of mixing the mixed curable component with the at least one organometallic compound (A), which is selected from the group consisting of the metal alkoxide and the metal chelate. Furthermore, the invention relates to a method for manufacturing the curing type adhesive composition recited in any one of the paragraphs concerned for polarizing film, the method comprising a first mixing step of mixing the at least one organometallic compound (A), which is selected from the group consisting of the metal alkoxide and the metal chelate, with the polymerizable compound (B), which has the polymerizable functional group and the carboxyl group, to yield an organometallic-compound-comprising composition, and a second mixing step of mixing the organometallic-compound-comprising composition with the active energy ray curable component.

The present invention also relates to a polarizing film comprising a polarizer, and a transparent protective film laid over at least one surface of the polarizer to interpose an adhesive layer between the film and the surface, wherein the adhesive layer is formed to comprise a layer of a cured product of the curing type adhesive composition recited in any one of the paragraphs concerned for polarizing film.

In the polarizing film, the adhesive layer preferably has a thickness of 0.1 to 3 μm. In the case of immersing the adhesive layer in pure water of 23° C. temperature for 24 hours, the adhesive layer preferably shows a bulk water absorption of 10% or less by weight, the bulk water absorption being represented by the following expression:

{(M2−M1)/M1}×100(%)

wherein M1: the weight of the cured product before the immersion, and M2: the weight of the cured product after the immersion. The adhesive layer preferably has a storage modulus of 1.0×10⁷ Pa or more at 25° C.

The present invention also relates to a method for manufacturing the polarizing film recited in any one of the paragraphs concerned, the method comprising: an applying step of applying the curing type adhesive composition for polarizing film to a surface of at least one of the polarizer and the transparent protective film, a bonding step of causing the polarizer and the transparent protective film to bond to each other, and an adhering step of radiating an active energy ray to the resultant bonded body from the polarizer surface side thereof, or the transparent protective film surface side thereof to cure the active energy ray curing type adhesive composition, and thereby adhering, through the resultant adhesive layer, the polarizer and the transparent protective film to each other.

Furthermore, the present invention also relates to an optical film on which one or more polarizing films as recited above are laminated; and an image display device wherein the following is used: the above-defined polarizing film or the above-defined optical film.

### Effect of the Invention

In the case of exposing, to a dew condensation environment, a polarizing film in which a transparent protective film is laminated over a polarizer to interpose an adhesive layer therebetween, a mechanism that adhesive peel is generated, particularly, between the adhesive layer and the polarizer is presumed as follows: Initially, water that has penetrated the protective film diffuses into the adhesive layer and the water diffuses to the polarizer interface side of the adhesive layer. In the polarizing film that is a polarizing film in the prior art, large is the degree of the contribution of hydrogen bonds and/or ion bonds to the adhering strength between the adhesive layer and the polarizer. However, the water which has diffused to the polarizer interface side causes the hydrogen bonds and the ion bonds to be dissociated in the interface to lower the adhering strength between the adhesive layer and the polarizer. In this way, in the dew concentration environment, adhesive peel may be generated between the adhesive layer and the polarizer.

In the meantime, the curing type adhesive composition for polarizing film according to the present invention includes at least one organometallic compound (A) selected from the group consisting of a metal alkoxide and a metal chelate. This organometallic compound (A) is turned to an active metal species by the intervention of water. As a result, the organometallic compound (A) interacts intensely with both of the polarizer, and the active energy ray curable component (X) included in the adhesive layer. In this way, adhesion water resistance is dramatically improved between the polarizer and the adhesive layer even when the water is present on the interface between the polarizer and the adhesive layer since these two members interact intensely with each other through the organometallic compound (A).

As described above, the organometallic compound (A) contributes largely to an improvement of the adhesive layer in adhesive performance and water resistance, this improvement being a target of the present invention. However, a composition containing this compound becomes unstable in liquid stability. This matter tends to cause the pot life to be shortened to deteriorate the composition in producibility. It is presumed that one reason therefor is as follows: the organometallic compound (A) is high in reactivity; thus, the compound contacts water contained in a trace amount in the composition to undergo hydrolysis reaction and self-condensation reaction; as a result, the compound is self-condensed, so that a liquid of the composition is made clouded (the generation of aggregations, phase separation, and precipitation). In the present invention, however, the composition includes not only the organometallic compound (A) but also the polymerizable compound (B), which has a polymerizable functional group and a carboxyl group; thus, the organometallic compound can be restrained from undergoing the hydrolysis reaction and the self-condensation reaction to be dramatically improved in liquid stability in the composition. Reasons that this advantageous effect is gained are unclear; however, the following reasons (1) and (2) can be supposed:

(1) The carboxyl group which the polymerizable compound (B) has is strongly bonded and/or coordinated to the metal which the organometallic compound (A) has to raise the electron density of the metal, so that the organometallic compound (A) can be decreased in force for attracting water molecules and other ligands.

(2) The organic compound B, which has a carboxyl group, further has a polymerizable functional group to be bulky, so that after the polymerizable compound (B) is bonded/and coordinated to the organometallic compound (A) to interpose, therebetween, the carboxyl group, other ligands do not easily approach the metal.

The composition according to the present invention is improved in liquid stability. Additionally, in a process in which the composition is cured to form an adhesive layer, a function of the organometallic compound (A) is not damaged even in the presence of the polymerizable compound (B), this function being a function that the compound (A) interacts strongly with both of a polarizer, and the active energy ray curable component (X), which is included in the adhesive layer. As a result, in the invention, the improvement of the composition in liquid stability can be consistent with an improvement of the resultant cured product in adhesive performance and water resistance.

About the curing type adhesive composition of the present invention for polarizing film, a cured product yielded by curing the curing type adhesive composition preferably has a bulk water absorption of 10% or less by weight. This bulk water absorption shows that in the case of forming an adhesive layer to include a cured product layer yielded by the curing type adhesive composition of the invention for polarizing film, the layer is very low in water absorption. Accordingly, a polarizing film in which a transparent protective film is laid over a polarizer to interpose, therebetween, an adhesive layer which is the cured product layer is good in adhesion to the polarizer and the transparent protective film, and can further satisfy optical endurance at a higher level in a severe environment at high temperature and high humidity.

For example, a polarizing film having a cured product layer (adhesive layer) formed using the curing type adhesive composition of the present invention for polarizing film is good in optical endurance (according to a humidity endurance test) in a severe humidified environment (for example, at 85° C.×85% RH) also. Therefore, even when the polarizing film of the invention is put into the severe humidified environment, a fall (change) of the polarizing film in transmittance and polarization degree can be controlled into a small level. Moreover, even when the polarizing film of the invention is put into a severe environment such as an environment in which the film is immersed in water, the polarizing film can be restrained from being lowered in adhering strength. Even under conditions that a contacting environment of the film with water is severe, the adhering strength between the polarizer and the transparent protective film (between the polarizer and the adhesive layer) can be restrained from being lowered.

### MODE FOR CARRYING OUT THE INVENTION

The curing type adhesive composition according to the present invention for polarizing film includes an active energy ray curable component (X), at least one organometallic compound (A) selected from the group consisting of a metal alkoxide and a metal chelate, and a polymerizable compound (B) having a polymerizable functional group and a carboxyl group.

<At Least One Organometallic Compound (A) Selected from Group Consisting of Metal Alkoxide and Metal Chelate>

The metal alkoxide is a compound to which at least one alkoxy group, which is an organic group, is bonded to a metal. The metal chelate is a compound in which an organic group is bonded or coordinated to a metal to interpose an oxygen atom therebetween. The metal is preferably titanium, aluminum, or zirconium. Out of these metals, aluminum and zirconium are larger in reactivity than titanium, so that the resultant adhesive composition may become short in pot life and the effect of improving the adhesion water resistance may be lowered. Accordingly, the metal in the organometallic compound is preferably titanium from the viewpoint of an improvement of the adhesive layer in adhesion water resistance.

When the curing type adhesive composition according to the present invention for polarizing film includes, as the organometallic compound, a metal alkoxide, it is preferred to use a metal alkoxide having an organic group having 3 or more carbon atoms, preferably 4 or more carbon atoms. If the number of the carbon atoms is 2 or less, the adhesive composition may become short in pot life, and the effect of improving the adhesion water resistance may be lowered. The organic group having 4 or more carbon atoms is, for example, a butoxy group. This group is favorably usable. Preferred examples of the metal alkoxide include tetraisopropyl titanate, tetra-n-butyl titanate, butyl titanate dimer, tetraoctyl titanate, tert-amyl titanate, tetra-tert-butyl titanate, tetrastearyl titanate, zirconium tetraisopropoxide, zirconium tetra-n-butoxide, zirconium tetraoctoxide, zirconium tetra-tert-butoxide, zirconium tetrapropoxide, aluminum sec-butylate, aluminum ethylate, aluminum isopropylate, aluminum butylate, aluminum diisopropylate mono-sec-butyrate, and mono-sec-butoxyaluminum diisopropylate. Out of these examples, tetrabutyl titanate is preferred.

When the curing type adhesive composition according to the present invention for polarizing film includes, as the organometallic compound, a metal chelate, the composition preferably includes a metal chelate having an organic group having 4 or more carbon atoms. If the number of the carbon atoms is 3 or less, the adhesive composition may become short in pot life, and the effect of improving the adhesion water resistance may be lowered. The organic group having 4 or more carbon atoms is, for example, an acetylacetonate group, an ethyl acetoacetate group, an isostearate group or an octyleneglycolate group. Out of these groups, an acetylacetonate group and an ethylacetoacetate group are preferred as the organic group from the viewpoint of an improvement of the adhesive layer in adhesion water resistance. Preferred examples of the metal chelate include titanium acetylacetonate, titanium octyleneglycolate, titanium tetraacetylacetonate, titanium ethylacetoacetate, polyhydroxytitanium stearate, dipropoxy-bis(acetylacetonate) titanium, di butoxy-bis(octylene glycolate), dipropoxytitanium-bis(ethylacetoacetate), titanium lactate, titanium diethanolaminate, titanium triethanolaminate, dipropoxytitanium-bis(lactate), dipropoxytitanium-bis(triethanolaminate), di-n-butoxytitanium-bis(triethanolaminate), tri-n-butoxytitanium monostearate, diisopropoxy.bis(ethylacetoacetate) titanium, diisopropoxy.bis(acetylacetate) titanium, diisopropoxy.bis(acetylacetone)titanium, titanium phosphate compounds, titanium lactate ammonium salt, titanium-1,3-propanedioxy-bis(ethylacetoacetate), dodecylbenzenesulfonic acid titanium compound, titanium aminoethylaminoethonolate, zirconium tetraacetylacetonate, zirconium monoacetylacetonate, zirconium bis acetylacetonate, zirconium acetylacetonate bisethylacetoacetate, zirconium acetate, tri-n-butoxyethylacetoacetatezirconium, di-n-butoxybis(ethylacetoacetate)zirconium, n-butoxytris(ethylacetoaetate)zirconium, tetrakis(n-propylacetoacetate)zirconium, tetrakis(acetylacetoacetate)zirconium, tetrakis(ethylacetoacetate)zirconium, aluminum ethylacetoacetate, aluminum acetylacetonate, aluminum acetylacetonate bisethylacetoacetate, diisopropoxyethylacetoacetatealuminum, diisopropoxyacetylacetonatealuminum, isopropoxybis(ethylacetoacetate)aluminum, isopropoxybis(acetylacetonate)aluminum, tris(ethylacetoacetate)aluminum, tris(acetylacetonate)aluminum, monoacetylacetonate and bis(ethylacetoacetate)aluminum. Out of these examples, titanium acetylacetonate and titanium ethylacetoacetate are preferred.

Examples of the organometallic compound usable in the present invention include, besides the above-mentioned examples, zinc octylate, zinc laurate, zinc stearate, tin octoate and other organic carboxylic acid metal salts; and acetylacetone zinc chelate, benzoylacetone zinc chelate, dibenzoylmethane zinc chelate, ethyl acetoacetate zinc chelate and other zinc chelate compounds.

In the present invention, the proportion of the organometallic compound (A) is preferably from 0.05 to 15% by weight, more preferably from 0.1 to 10% by weight for 100% by weight of the whole of the curing type adhesive composition for polarizing film. If the blend amount is more than 15% by weight, it is feared that the adhesive composition is deteriorated in storage stability and the proportion of components to be bonded to a polarizer or a protective film is relatively short so that the adhesive composition may be lowered in adhesive performance. If the blend amount is less than 0.05% by weight, the advantage for the adhesion water resistance may be not sufficiently exhibited.

### <Polymerizable Compound (B) Having Polymerizable Functional Group and Carboxyl Group>

The polymerizable compound (B) has a polymerizable functional group and a carboxyl group. The polymerizable compound (B) may contain two or more polymerizable functional groups and two or more carboxyl groups.

The polymerizable functional group or each of the polymerizable functional groups is not particularly limited. Examples thereof include a carbon-carbon-double-bond-containing group, an epoxy group, an oxetanyl group, and a vinyl ether group.

In particular, the polymerizable functional group is preferably a radical polymerizable functional group represented by the following general formula (I):

H₂C═C(R¹)—COO— (I)

wherein R¹ represents hydrogen or an organic group having 1 to 20 carbon atoms; or the following general formula (II):

H₂C═C(R²)—R³— (II)

wherein R¹ represents hydrogen or an organic group having 1 to 20 carbon atoms, and R³ represents a direct bond or an organic group having 1 to 20 carbon atoms. The polymerizable functional group is in particular preferably a radical polymerizable functional group in which R¹ and R² are each hydrogen or a methyl group in the formula.

The bonding position of the carboxyl group in the polymerizable compound (B) is not particularly limited. From the viewpoint of an improvement of the organometallic compound (A) in liquid stability in the composition, the following is more preferred than (meth)acrylic acid, in which a radical polymerizable functional group is directly bonded to a carboxyl group: a radical polymerizable compound in which a radical polymerizable functional group is bonded to a carboxyl group to interpose, therebetween, an organic group which has 1 to 20 carbon atoms and may contain oxygen.

From the viewpoint of an improvement of the organometallic compound (A) in liquid stability in the composition, it is preferred that the polymerizable compound (B) is large in molecular weight, and the compound (B) is bulky at the time of being bonded and/or coordinated to the organometallic compound (A), and comes to give a steric hindrance when a different ligand is coordinated thereto. When the polymerizable compound (B) comes to give the steric hindrance, the organometallic compound (A) is lowered in reaction rates of ligand substitution reaction, hydrolysis reaction and condensation reaction so as to be stabilized. Accordingly, the molecular weight of the polymerizable compound (B) is preferably 100 (g/mol) or more, more preferably 125 (g/mol) or more, even more preferably 150 (g/mol) or more, in particular preferably 200 (g/mol) or more, most preferably 250 (g/mol) or more. The upper limit of the molecular weight of the polymerizable compound (B) is not particularly limited, and is preferably 400 (g/mol) or less, more preferably 350 (g/mol) or less.

From the viewpoint of an improvement of the organometallic compound (A) in liquid stability in the composition, the polymerizable compound (B) is preferably a polymerizable compound having a polymerizable functional group and a carboxyl group to interpose, between these groups, an organic group which has 1 to 20 carbon atoms and may contain oxygen. Examples of the organic group include an alkyl group, an alkenyl group, an alkynyl group, an alkylidene group, an alicyclic group, an unsaturated alicyclic group, an alkyl ester group, an aromatic ester group, an acyl group, a hydroxyalkyl group, and an alkylene oxide group. Only one of these organic groups may be bonded thereto; or a plurality of the same organic groups, or a plurality of different organic groups may be bonded thereto. Specific examples of the polymerizable compound (B) include β-carboxyethyl acrylate, carboxypentyl acrylate, β-carboxyethyl methacrylate, 2-acryloyloxyethyl-succinic acid, 2-acryloyloxyethylhexahydrophthalic acid, 2-acryloyloxyethylphthalic acid, ω-carboxy-polycaprolactone monoacrylate, 2-acryloyloxyethyltetrahydrophthalic acid, 2-acryloyloxypropyloxyphthalic acid, 2-acryloyloxypropyltetrahydrophthalic acid, 2-acryloyloxypropylhexahydrophthalic acid, methacryloyloxyethylsuccinic acid, methacryloyloxyethylphthalic acid, methacryloyloxyethyltetrahydrophthalic acid, methacryloyloxyethylhexahydrophthalic acid, 2-methacryloyloxypropyloxyphthalic acid, 2-methacryloyloxypropyltetrahydrophthalic acid, and 2-methacryloyloxypropylhexahydrophthalic acid.

When the total amount of the organometallic compound (A) in the curing type adhesive composition for polarizing film is represented by a (mol), the content of the polymerizable compound (B) in the composition is preferably 0.25α (mol) or more, more preferably 0.35α (mol) or more, even more preferably 0.5α (mol) or more, in particular preferably 1α (mol) or more from the viewpoint of an improvement of the organometallic compound (A) in liquid stability in the composition. If the content of the polymerizable compound (B) is too small, the organometallic compound (A) becomes insufficient in stability so that the hydrolysis reaction and self-condensation reaction thereof advance easily. Thus, the composition may be shortened in pot life. The upper limit of the content of the polymerizable compound (B) relative to the total amount a (mol) of the organometallic compound (A) is preferably less than 200α (mol), more preferably less than 100α (mol), even more preferably less than 20α (mol), in particular preferably less than 6α (mol), most preferably less than 2α (mol). If the content of the polymerizable compound (B) is too large, the organometallic compound is excessively stabilized so that the adhesive composition is easily hindered from undergoing reaction with a polarizer and the adhesive layer. Consequently, the adhesive layer may be poor in adhesive performance and water resistance.

### <Organic-Metal-Compound-Containing Composition>

The curing type adhesive composition according to the present invention for polarizing film may be a composition yielded by mixing the active energy ray curable component (X), the organometallic compound (A) and the polymerizable compound (B) simultaneously with each other, or may be a composition yielded by producing, in advance, an organometallic-compound-containing composition containing the organometallic compound (A) and the polymerizable compound (B), and mixing this composition with the active energy ray curable component (X).

As described above, in the curing type adhesive composition for polarizing film, the carboxyl group which the polymerizable compound (B) has is strongly bonded and/or coordinated to the metal which the organometallic compound (A) has, thereby stabilizing the organometallic compound (A). When the organometallic compound (A) and the polymerizable compound (B) are beforehand mixed and caused to react with each other in the absence of any active energy ray curable component (X) or the like, the reaction rate and/or coordination rate between these components is/are dramatically raised so that the resultant organometallic-compound-containing composition comes to contain a reaction product and a coordination product between the organometallic compound (A) and the polymerizable compound (B) at a high concentration. Accordingly, in the resultant organometallic-compound-containing composition, the organometallic compound (A) is very high in stability. Thus, also in a curing type adhesive composition, for polarizing film, containing this composition, the organometallic compound (A) is very high in stability in the same manner. About a method for manufacturing the curing type adhesive composition of the present invention for polarizing film, a description will be made later.

### <Active Energy Ray Curable Component (X)>

The curing type adhesive composition of the present invention for polarizing film includes, as a curable component, an active energy ray curable component (X).

The active energy ray curable component (X) is preferably of an electron beam curing type, an ultraviolet-ray curing type, a visible-ray curing type or some other type. The ultraviolet-ray curing type and visible-ray curing type adhesive compositions can be each further classified to a radical polymerization curing type adhesive composition or a cation polymerization type adhesive composition. In the present invention, any active energy ray having a wavelength in the range of 10 nm or more and less than 380 nm is referred to as an ultraviolet ray; and any active energy ray having a wavelength in the range of 380 to 800 nm, as a visible ray.

### <1. Radical Polymerization Curing Type Adhesive Composition>

The above-mentioned curable component is, for example, a radical polymerizable compound used in a radical polymerization curing type adhesive composition. The radical polymerizable compound may be a compound having a radical polymerizable functional group having a carbon-carbon double bond, such as a (meth)acryloyl group or a vinyl group. Such a curable component may be either a monofunctional radical polymerizable compound or a polyfunctional radical polymerizable compound having bi-functionality or any higher functionality. Such radical polymerizable compounds may be used singly or in any combination of two or more thereof. The radical polymerizable compound is preferably a compound having a (meth)acryloyl group. In the present invention, the word “(meth)acryloyl” means an acryloyl group and/or a (meth)acryloyl group. The notation “(meth)a” has substantially the same meaning hereinafter.

### <<Monofunctional Radical Polymerizable Compound>>

The monofunctional radical polymerizable compound is, for example, a (meth)acrylamide derivative having a (meth)acrylamide group. The (meth)acrylamide derivative is preferred since the derivative causes the resultant adhesive layer to keep adhesion to a polarizer and various transparent protective films, and is large in polymerization rate to give an excellent productivity. Specific examples of the (meth)acrylamide derivative include N-methyl(meth)acrylamide, N,N-dimethyl(meth)acrylamide, N,N-diethyl(meth)acrylamide, N-isopropyl(meth)acrylamide, N-butyl(meth)acrylamide, N-hexyl(meth)acrylamide, and other N-alkyl-group-containing (meth)acrylamide derivatives; N-methylol(meth)acrylamide, N-hydroxyethyl(meth)acrylamide, N-methylol-N-propane(meth)acrylamide, and other N-hydroxyalkyl-group-containing (meth)acrylamide derivatives; aminomethyl(meth)acrylamide, aminoethyl(meth)acrylamide, and other N-aminoalkyl-group-containing (meth)acrylamide derivatives; N-methoxymethylacrylamide, N-ethoxymethylacrylamide, and other N-alkoxy-group-containing (meth)acrylamide derivatives; and mercaptomethyl(meth)acrylamide, mercaptoethyl(meth)acrylamide, and N-mercaptoalkyl-group-containing (meth)acrylamide derivatives. Examples of a heterocycle-containing (meth)acrylamide derivative, in which a nitrogen atom of a (meth)acrylamide group is included in a heterocycle, include N-acryloylmorpholine, N-acryloylpiperidine, N-methacryloylpiperidine, and N-acryloylpyrrolidine.

Out of these (meth)acrylamide derivatives, N-hydroxyalkyl-group-containing (meth)acrylamide derivatives are preferred from the viewpoint of the adhesion of the resultant adhesive layer to a polarizer and various transparent protective films. N-hydroxyethyl(meth)acrylamide is particularly preferred.

Other examples of the monofunctional radical polymerizable compound include various (meth)acrylic acid derivatives each having a (meth)acryloyloxy group. Specific examples of the derivatives include methyl (meth)acrylate, ethyl (meth)acrylate, n-propyl (meth)acrylate, isopropyl (meth)acrylate, 2-methyl-2-nitro-propyl (meth)acrylate, n-butyl (meth)acrylate, isobutyl (meth)acrylate, s-butyl (meth)acrylate, t-butyl (meth)acrylate, n-pentyl (meth)acrylate, t-pentyl (meth)acrylate, 3-pentyl (meth)acrylate, 2,2-dimethylbutyl (meth)acrylate, n-hexyl (meth)acrylate, cetyl (meth)acrylate, n-octyl (meth)acrylate, 2-ethylhexyl (meth)acrylate, 4-methyl-2-propylpentyl (meth)acrylate, n-octadecyl (meth)acrylate, and other (C₁ to C₂₀) alkyl esters of (meth)acrylic acid.

Other examples of the above-mentioned (meth)acrylic acid derivatives include cyclohexyl (meth)acrylate, cyclopentyl (meth)acrylate, and other cycloalkyl (meth)acrylates; benzyl (meth)acrylate, and other aralkyl (meth)acrylates; 2-isobornyl (meth)acrylate, 2-norbornylmethyl (meth)acrylate, 5-norbornene-2-yl-methyl (meth)acrylate, 3-methyl-2-norbornylmethyl (meth)acrylate, dicyclopentenyl (meth)acrylate, dicyclopentenyloxyethyl (meth)acrylate, dicyclopentanyl (meth)acrylate, and other polycyclic (meth)acrylates; and 2-methoxyethyl (meth)acrylate, 2-ethoxyethyl (meth)acrylate, 2-methoxymethoxyethyl (meth)acrylate, 3-methoxybutyl (meth)acrylate, ethylcarbitol (meth)acrylate, phenoxyethyl (meth)acrylate, an alkylphenoxy polyethylene glycol (meth)acrylate, and other alkoxy-group- or phenoxy-group-containing (meth)acrylates.

Other examples of the (meth)acrylic acid derivatives include 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and other hydroxyalkyl (meth)acrylates; [4-(hydroxymethyl)cyclohexyl]methyl acrylate, cyclohexanedimethanol mono(meth)acrylate, 2-hydroxy-3-phenoxypropyl (meth)acrylate, and other hydroxyl-group-containing (meth)acrylates; glycidyl (meth)acrylate, 4-hydroxybutyl (meth)acrylate glycidyl ether, and other epoxy-group-containing (meth)acrylates; 2,2,2-trifluoroethyl (meth)acrylate, 2,2,2-trifluoroethylethyl (meth)acrylate, tetrafluoropropyl (meth)acrylate, hexafluoropropyl (meth)acrylate, octafluoropentyl (meth)acrylate, heptadecafluorodecyl (meth)acrylate, 3-chloro-2-hydroxypropyl (meth)acrylate, and other halogen-containing (meth)acrylates; dimethylaminoethyl (meth)acrylate, and other alkylaminoalkyl (meth)acrylates; 3-oxetanylmethyl (meth)acrylate, 3-methyl-oxetanylmethyl (meth)acrylate, 3-ethyl-oxetanylmethyl (meth)acrylate, 3-butyl-oxetanylmethyl (meth)acrylate, 3-hexyl-oxetanylmethyl (meth)acrylate, and other oxetanyl-group-containing (meth)acrylates; tetrahydrofurfuryl (meth)acrylate, butyrolactone (meth)acrylate, and other (meth)acrylates each having a heterocycle; hydroxypivalic acid neopentyl glycol (meth)acrylic acid adduct; and p-phenylphenol (meth)acrylate.

Examples of the monofunctional radical polymerizable compound include (meth)acrylic acid, carboxyethyl acrylate, carboxypentyl acrylate, itaconic acid, maleic acid, fumaric acid, crotonic acid, isocrotonic acid, and other carboxyl-group-containing monomers.

Other examples of the monofunctional radical polymerizable compound include N-vinylpyrrolidone, N-vinyl-ε-caprolactam, methylvinylpyrrolidone, and other lactam-based vinyl monomers; vinylpyridine, vinylpiperidone, vinylpyrimidine, vinylpiperazine, vinylpyrazine, vinylpyrrole, vinylimidazole, vinyloxazole, vinyl morpholine, and other vinyl-containing monomers each having a nitrogen-containing heterocycle.

The monofunctional radical polymerizable compound may be a radical polymerizable compound having an active methylene group. The radical polymerizable compound having an active methylene group is a compound which has, at a terminal thereof or in the molecule thereof, an active double bond group such as a (meth)acryl group and which has an active methylene group. Examples of the active methylene group include an acetoacetyl group, alkoxymalonyl groups, and a cyanoacetyl group. The active methylene group is preferably an acetoacetyl group. Specific examples of the radical polymerizable compound having an active methylene group include 2-acetoacetoxyethyl (meth)acrylate, 2-acetoacetoxypropyl (meth)acrylate, 2-acetoacetoxy-1-methylethyl (meth)acrylate, and other acetoacetoxyalkyl (meth)acrylates; 2-ethoxymalonyloxyethyl (meth)acrylate, 2-cyanoacetoxyethyl (meth)acrylate, N-(2-cyanoacetoxyethyl)acrylamide, N-(2-propionylacetoxybutyl)acrylamide, N-(4-acetoacetoxymethylbenzyl)acrylamide, and N-(2-acetoacetylaminoethyl)acrylamide. The radical polymerizable compound having an active methylene group is preferably an acetoacetoxyalkyl (meth)acrylate.

### <<Polyfunctional Radical Polymerizable Compound>>

Examples of the polyfunctional radical polymerizable compound having bi-functionality or any higher-functionality include N,N′-methylenebis(meth)acrylamide, which is a polyfunctional (meth)acrylamide derivative, tripropylene glycol di(meth)acrylate, tetraethylene glycol di(meth)acrylate, 1,6-hexanediol di(meth)acrylate, 1,9-nonanediol di(meth)acrylate, 1,10-decanediol diacrylate, 2-ethyl-2-butyl-propanediol di(meth)acrylate, bisphenol A di(meth)acrylate, bisphenol A ethylene oxide adduct di(meth)acrylate, bisphenol A propylene oxide adduct di(meth)acrylate, bisphenol A diglycidyl ether di(meth)acrylate, neopentyl glycol di(meth)acrylate, tricyclodecanedimethanol (meth)acrylate, cyclic trimethylolpropaneformyl(meth)acrylate, dioxane glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, EO-modified diglycerin tetra(meth)acrylate, and other esterified products each made from (meth)acrylic and a polyhydric alcohol; and 9,9-bis[4-(2-(meth)acryloyloxyethoxy)phenyl]fluorene. Specific and preferred examples thereof include products ARONIX M-220 (manufactured by Toagosei Co., Ltd.), LIGHT ACRYLATE 1,9 ND-A (manufactured by Kyoeisha Chemical Co., Ltd.), LIGHT ACRYLATE DGE-4A (manufactured by Kyoeisha Chemical Co., Ltd.), LIGHT ACRYLATE DCP-A (manufactured by Kyoeisha Chemical Co., Ltd.), SR-531 (manufactured by Sartomer Chemicals Co., Ltd., and CD-536 (manufactured by Sartomer Chemicals Co., Ltd.). As the need arises, the following may be used: various epoxy (meth)acrylates, urethane (meth)acrylates and polyester (meth)acrylates, and various (meth)acrylate-based monomers. It is preferred to incorporate a polyfunctional(meth)acrylamide derivative into the curable resin composition since the derivative is large in polymerization rate to be excellent in productivity, and when the resin composition is made into a cured product, the cured product is excellent in cross-linkability.

It is preferred that the radical polymerizable compound contains the polyfunctional radical polymerizable compound to control the water absorption of the cured product and cause the resultant polarizing film to satisfy optical endurance in a severe humidified environment. Out of polyfunctional radical polymerizable compounds as described above, preferred is a compound having a high log Pow value, which will be detailed below.

It is preferred that the curing type adhesive composition of the present invention for polarizing film has a high octanol/water distribution coefficient (hereinafter referred to as a log Pow value). The log Pow value of a substance is an index representing the lipophilicity of the substance, and is a logarithmic value of the octanol/water distribution coefficient thereof. The matter that a substance is higher in log Pow value means that the substance is more lipophilic, that is, that the substance is lower in water absorption. The log Pow value is measurable (by a flask shaking method described in JIS-Z-7260); however, the value is also calculable out by calculation. The document DESCRIPTION makes use of log Pow values each calculated through a product ChemDraw Ultra manufactured by Cambridge Soft Corp. The log Pow value of any adhesive composition can be calculated by the following expression:

Log Pow value of the adhesive composition=Σ(log Powi×Wi)

wherein log Powi: the log Pow value of each component of the composition; and Wi: (the mole number of the component “i”)/(the total mole number in the adhesive composition).

The log Pow value of the curing type adhesive composition of the present invention is preferably 1 or more, more preferably 2 or more, most preferably 3 or more.

Examples of the radical polymerizable compound high in log Pow value include alicyclic (meth)acrylates such as tricyclodecanedimethanol di(meth)acrylate (log Pow=3.05), and isobornyl (meth)acrylate (log Pow=3.27); long-chain aliphatic (meth)acrylates such as 1,9-nonanediol di(meth)acrylate (log Pow=3.68), and 1,10-decanediol diacrylate (log Pow=4.10); multi-branched (meth)acrylates such as hydroxypivalic acid neopentyl glycol (meth)acrylic acid adduct (log Pow=3.35), and 2-ethyl-2-butylpropanediol di(methyl)acrylate (log Pow=3.92); and (meth)acrylates each having an aromatic ring, such as bisphenol A di(meth)acrylate (log Pow=5.46), bisphenol A ethylene oxide 4-mol adduct di(meth)acrylate (log Pow=5.15), bisphenol A propylene oxide 2-mol adduct di(meth)acrylate (log Pow=6.10), bisphenol A propylene oxide 4-mol adduct di(meth)acrylate (log Pow=6.43), 9,9-bis[4-(2-(meth)acryloyloxyethoxy)phenyl]fluorene (log Pow=7.48), and p-phenylphenol (meth)acrylate (log Pow=3.98).

It is preferred to use, as the radical polymerizable compound(s), a combination of the monofunctional radical polymerizable compound and the polyfunctional radical polymerizable compound in order to cause the resultant adhesive layer to be made consistent between adhesion to a polarizer and various transparent protective films, and optical endurance in a severe environment. Usually, it is preferred to use the two together to set the proportion of the monofunctional radical polymerizable compound in the range of 3 to 80% by weight for 100% by weight of the radical polymerizable compounds and set the proportion of the polyfunctional radical polymerizable compound in that of 20 to 97% by weight therefor.

### <Embodiments of Radical Polymerization Curing Type Adhesive Composition>

In the curing type adhesive composition of the present invention for polarizing film, the curable component thereof may be used as an active energy ray curable component. In this case, the composition is usable as an active energy ray curing type adhesive composition. When, e.g., an electron beam is used as the active energy ray, the active energy ray curing type adhesive composition does not need to contain any photopolymerization initiator. However, when an ultraviolet ray or visible ray is used as the active energy ray, it is preferred that the adhesive composition contains a photopolymerization initiator.

### <<Photopolymerization Initiator>>

When the radical polymerizable compound is used, the photopolymerization initiator is appropriately selected in accordance with the active energy ray. When the radical polymerizable compound is cured by ultraviolet rays or visible rays, a photopolymerization initiator is used which is cleaved by the ultraviolet or visible rays. Examples of the photopolymerization initiator include benzil, benzophenone, benzoylbenzoic acid, 3,3′-dimethyl-4-methoxybenzophenone, and other benzophenone-based compounds; 4-(2-hydroxyethoxy)phenyl (2-hydroxy-2-propyl) ketone, α-hydroxy-α,α′-dimethylacetophenone, 2-methyl-2-hydroxypropiophenone, α-hydroxycyclohexyl phenyl ketone, and other aromatic ketone compounds; methoxyacetophenone, 2,2-dimethoxy-2-phenylacetophenone, 2,2-diethoxyacetophenone, 2-methyl-1-[4-(methylthio)-phenyl]-2-morpholinopropane-1, and other acetophenone-based compounds; bezoin methyl ether, benzoin ethyl ether, benzoin isopropyl ether, benzoin butyl ether, anisoin methyl ether, and other benzoin ether compounds; benzyl dimethyl ketal, and other aromatic ketal compounds; 2-naphthalenesulfonyl chloride, and other aromatic sulfonyl chloride compounds; 1-phenone-1,1-propanedione-2-(o-ethoxycarbonyl)oxime, and other optically active oxime-based compounds; thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, dodecylthioxanthone, and other thioxanthone-based compounds; camphorquinone; halogenated ketones; acylphosphinoxide; and acyl phosphonate. Out of such photopolymerization initiators, an initiator high in log Pow value is preferred. The log Pow value of the photopolymerization initiator is preferably 2 or more, more preferably 3 or more, most preferably 4 or more.

The blend amount of the photopolymerization initiator is 20 parts or less by weight for 100 parts by weight of the whole of the curable component (radical polymerizable compound). The blend amount of the photopolymerization initiator is preferably from 0.01 to 20 parts by weight, more preferably from 0.05 to 10 parts by weight, even more preferably from 0.1 to 5 parts by weight.

When the curing type adhesive composition of the present invention for polarizing film is used in the form of a visible ray curing type which contains, as the curable component thereof, a radical polymerizable compound, it is particularly preferred to use a photopolymerization initiator high in sensitivity to light rays having wavelengths of 380 nm or more. The photopolymerization initiator high in sensitivity to light rays having wavelengths of 380 nm or more will be detailed later.

It is preferred to use, as the photopolymerization initiator, a compound represented by the following general formula (1):

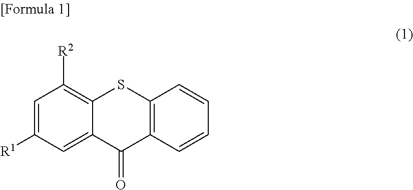

wherein R¹ and R² are each —H, —CH₂CH₃, -iPr or Cl, and R¹ and R² may be the same as or different from each other; singly or use the compound represented by the general formula (1) together with a photopolymerization initiator high in sensitivity to light rays having wavelengths of 380 nm or more, which will be detailed later. In the case of using the compound represented by the general formula (1), the resultant adhesive composition is better in adhesive performance than in the case of using the photopolymerization initiator high in sensitivity to light rays having wavelengths of 380 nm or more singly. Out of compounds each represented by the general formula (1), particularly preferred is diethylthioxanthone, in which R¹ and R² are each —CH₂CH₃ in the formula. The composition proportion of the compound represented by the general formula (1) in the adhesive composition is preferably from 0.1 to 5 parts by weight, more preferably from 0.5 to 4 parts by weight, even more preferably from 0.9 to 3 parts by weight for 100 parts by weight of the whole of the curable component.

As required, a polymerization initiation aid is preferably added to the composition. Examples of the polymerization initiation aid include triethylamine, diethylamine, N-methyldiethanolamine, ethanolamine, 4-dimethylaminobenzoic acid, methyl 4-dimethylaminobenzoate, ethyl 4-dimethylaminobenzoate, and isoamyl 4-dimethylaminobenzoate. Particularly preferred is ethyl 4-dimethylaminobenzoate. When the polymerization initiation aid is used, the addition amount thereof is usually from 0 to 5 parts by weight, preferably from 0 to 4 parts by weight, most preferably from 0 to 3 parts by weight for 100 parts by weight of the whole of the curable component.

As required, a known photopolymerization initiator may be together used. A transparent protective film having UV absorbing power does not transmit any light ray having a wavelength of 380 nm or less. Thus, the photopolymerization initiator is preferably a photopolymerization initiator high in sensitivity to light rays having wavelengths of 380 nm or more. Specific examples thereof include 2-methyl-1-(4-methylthiophenyl)-2-morpholinopropane-1-one, 2-benzyl-2-dimethylamino-1-(4-morpholinophenyl)-butanone-1, 2-(dimethylamino)-2-[(4-methylphenyl)methyl]-1-[4-(4-morpholinyl)phenyl]-1-butanone, 2,4,6-trimethylbenzoyl-diphenyl-phosphine oxide, bis(2,4,6-trimethylbenzoyl)-phenylphosphine oxide, and bis(η5-2,4-cyclopentadiene-1-yl)-bis(2,6-difluoro-3-(1H-pyrrol-1-yl)-phenyl)titanium.

It is particularly preferred that in addition to the photopolymerization initiator of the general formula (1), a compound represented by the following general formula (2) is further used:

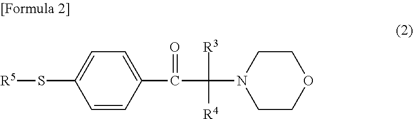

wherein R³, R⁴ and R⁵ are each —H, —CH₃, -iPr or Cl, and may be the same as or different from each other. The compound represented by the general formula (2) may be 2-methyl-1-(4-methylthiophenyl)-2-morpholinopropane-1-one, which is also a commercially available product (trade name: IRGACURE 907, manufacturer: the BASF). Furthermore, the following are preferred because of a high sensitivity thereof: 2-benzyl-2-dimethylamino-1-(4-morpholinophenyl)-butanone-1 (trade name: IRGACURE 369, manufacturer: the BASF), 2-(dimethylamino)-2-[(4-methylphenyl)methyl]-1-[4-(4-morpholinyl)phenyl]-1-butanone (trade name: IRGACURE 379, manufacturer: the BASF).

### <Radical Polymerizable Compound (a1) Having Active Methylene Group, and Radical Polymerization Initiator (a2) Having Hydrogen-Withdrawing Effect>

When a radical polymerizable compound (a1) having an active methylene group is used as the radical polymerizable compound in the active energy ray curing type adhesive composition, it is preferred to use a combination of the compound (a1) with a radical polymerization initiator (a2) having hydrogen-withdrawing effect. This structure makes a remarkable improvement of the adhesive layer which a polarizing film has in adhesive performance (when the film is in a non-dry state) even immediately after the film is taken out, particularly, from a high-humidity environment or water. The reason therefor is unclear; however, the reason would be as follow: while the radical polymerizable compound (a1) having an active methylene group is being polymerized together with the other radical polymerizable compound(s) included in the adhesive layer, the radical polymerizable compound (a1) is taken into the main chain and/or side chains of the base polymer in the adhesive layer; consequently, the adhesive layer is formed. In this polymerizing step, when the radical polymerization initiator (a2) having hydrogen-withdrawing effect is present, the base polymer, which is to be included in the adhesive layer, is being produced and further hydrogen is withdrawn from the radical polymerization compound (a2) having an active methylene group, so that radicals are generated in the methylene group. The radical-generated methylene group reacts with hydroxyl groups of PVA or the like in the polarizer, so that covalent bonds are formed between the adhesive layer and the polarizer. It is presumed that this bond-formation results in the remarkable improvement of the adhesive layer, which the polarizing film has, in adhesive performance.

In the present invention, the radical polymerization initiator (a2) having hydrogen-withdrawing effect is, for example, a thioxanthone-based radical polymerization initiator, or a benzophenone-based radical polymerization initiator. The radical polymerization initiator (a2) is preferably a thioxanthone-based radical polymerization initiator. The thioxanthone-based radical polymerization initiator is, for example, a compound represented by the general formula (1). Specific examples of the compound represented by the general formula (1) include thioxanthone, dimethyl thioxanthone, diethyl thioxanthone, isopropyl thioxanthone, and chlorothioxanthone. Out of compounds each represented by the general formula (1), particularly preferred is diethylthioxanthone, in which R¹ and R² are each —CH₂CH₃ in the formula.

When the active energy ray curing type adhesive composition contains the radical polymerizable compound (a1) having an active methylene group and the radical polymerization initiator (a2) having hydrogen-withdrawing effect, it is preferred to incorporate, into the composition, the radical polymerizable compound (a1) having the active methylene group in a proportion of 1 to 50% by weight for 100% by weight of the whole of curable components, and incorporate the radical polymerization initiator (a2) thereinto in an amount of 0.1 to 10 parts by weight for 100 parts by weight of the whole of the curable components.

As described above, in the present invention, in the presence of the radical polymerization initiator (a2) having hydrogen-withdrawing effect, radicals are caused to be generated in the radical polymerizable compound (a1) having an active methylene group and at the active methylene group. This methylene group reacts with hydroxyl groups of PVA or the like in the polarizer to form covalent bonds. Thus, in order to cause the generation of radicals in the radical polymerizable compound (a1) having an active methylene group and at the methylene group to form such covalent bonds sufficiently, the adhesive composition contains the radical polymerizable compound (a1) having the active methylene group in a proportion preferably from 1 to 50% by weight, more preferably from 3 to 30% by weight for 100% by weight of the whole of the curable components. In order to improve the adhesive composition sufficiently in water resistance to be improved in adhesive performance in a non-dry state, it is preferred to set the proportion of the radical polymerizable compound (a1) having an active methylene group to 1% or more by weight. In the meantime, if the proportion is more than 50% by weight, the adhesive layer may be insufficiently cured. The adhesive composition contains the radical polymerization initiator (a2) having hydrogen-withdrawing effect in an amount preferably from 0.1 to 10 parts, more preferably from 0.3 to 9 parts by weight for 100 parts by weight of the whole of the curable component(s). In order to cause the hydrogen-withdrawing reaction to advance sufficiently, it is preferred to use the radical polymerization initiator (a2) in an amount of 0.1 part or more by weight. In the meantime, if the amount is more than 10 parts or more by weight, the radical polymerization initiator (a2) may not be completely dissolved in the composition.

### <2: Cation Polymerization Curing Type Adhesive Composition>

The cation polymerizable compound used in the cation polymerization curable resin composition is classified into a monofunctional cation polymerizable compound, which has in the molecule thereof a single cation polymerizable functional group, or a polyfunctional cation polymerizable compound, which has in the molecule thereof two or more cation polymerizable functional groups. The monofunctional cation polymerizable compound is relatively low in liquid viscosity; thus, when this compound is incorporated into the resin composition, the resin composition can be lowered in liquid viscosity. Moreover, in many cases, the monofunctional cation polymerizable compound has a functional group for expressing various functions. Thus, the incorporation of this compound into the resin composition can cause various functions to be expressed in the resin composition and/or a cured product of the resin composition. The polyfunctional cation polymerizable compound makes it possible to crosslink the cure product of the resin composition three-dimensionally. Thus, this compound is preferably incorporated into the resin composition. About the ratio between the monofunctional cation polymerizable compound and the polyfunctional cation polymerizable compound, the polyfunctional cation polymerizable compound is preferably blended into the former in an amount of 10 to 1000 parts by weight for 100 parts by weight of the monofunctional cation polymerizable compound. The cation polymerizable functional group may be an epoxy, oxetanyl or vinyl ether group. Examples of a compound having the epoxy group include aliphatic epoxy compounds, alicyclic epoxy compounds, and aromatic epoxy compounds. The cation polymerization curable resin composition of the present invention in particular preferably contains an alicyclic epoxy compound since the composition is excellent in curability and adhesive performance. Examples of the alicyclic epoxy compound include 3,4-epoxycyclohexylmethyl-3,4-epoxycyclohexane carboxylate, and caprolactone-modified products, trimethyl caprolactone modified products or valerolactone-modified products of 3,4-epoxycyclohexylmethyl-3,4-epoxycyclohexane carboxylate. Specific examples thereof include products CELLOXIDE 2021, CELLOXIDE 2021A, CELLOXIDE 2021P, CELLOXIDE 2081, CELLOXIDE 2083, CELLOXIDE 2085 (each manufactured by Daicel Corp); and CYRACURE UVR-6105, CYRACURE UVR-6107, CYRACURE 30, and R-6110 (each manufactured by Dow Chemical Japan Ltd.). It is preferred to incorporate a compound having an oxetanyl group into the cation polymerizable curable resin composition of the present invention since the compound has advantageous effects of improving the composition in curability and lower the composition in liquid viscosity. Examples of the compound having an oxetanyl group include 3-ethyl-3-hydroxymethyloxetane, 1,4-bis[(3-ethyl-3-oxetanyl)methoxymethyl]benzene, 3-ethyl-3-(phenoxymethyl)oxetane, di[(3-ethyl-3-oxetanyl)methyl] ether, 3-ethyl-3-(2-ethylhexyloxymethyl)oxetane, and phenol novolac oxetane. The following are commercially available: products ARON OXETANE OXT-101, ARON OXETANE OXT-121, ARON OXETANE OXT-211, ARON OXETANE OXT-221, and ARON OXETANE OXT-212 (each manufactured by Toagosei Co., Ltd.). Examples of a compound having a vinyl ether group include 2-hydroxyethyl vinyl ether, diethylene glycol monovinyl ether, 4-hydroxybutyl vinyl ether, diethylene glycol monovinyl ether, triethylene glycol divinyl ether, cyclohexanedimethanol divinyl ether, cyclohexanedimethanol monovinyl ether, tricyclodecane vinyl ether, cyclohexyl vinyl ether, methoxyethyl vinyl ether, ethoxyethyl Vinyl ether, and pentaerythritol type tetravinyl ether.

### <Cation Photopolymerization Initiator>

The cation polymerization curable resin composition includes, as a curable component, at least one compound selected from the above-mentioned compound having an epoxy group, compound having an oxetanyl group and compound having a vinyl ether, and these compounds are each cured by cation polymerization. Thus, a cation photopolymerization initiator is blended into the composition. This cation photopolymerization initiator is irradiated with an active energy ray such as a visible ray, an ultraviolet ray, an X ray or an electron beam to generate a cationic species or Lewis acid to initiate the polymerization reaction of epoxy groups and oxetanyl groups. The cation photopolymerization initiator is preferably an optical acid-generator which will be detailed later. When the curable resin composition used in the present invention is used in a visible ray curable form, it is particularly preferred to use a cation photopolymerization initiator high in sensitivity to light rays having wavelengths of 380 nm or more. In general, cation photopolymerization initiators are each a compound showing a maximum absorption near 300 nm or in the range of wavelengths shorter than 300 nm. Thus, by blending, into the composition, a photosensitizer showing a maximum absorption in the range of wavelengths longer than 300 nm, specifically, wavelengths longer than 380 nm, the photosensitizer sensitizes light rays each having a wavelength near this wavelength so that the generation of a cation species or acid can be promoted from the cation photopolymerization initiator. Examples of the photosensitizer include anthracene compounds, pyrene compounds, carbonyl compounds, organic sulfur compounds, persulfates, redox compounds, azo and diazo compounds, halogenated compounds, and optically reducible colorants. These photosensitizers may be used in the form of a mixture of two or more thereof. In particular, anthracene compounds are preferred because of an excellent photosensitizing effect thereof. Specific examples thereof include products ANTHRACURE UVS-1331, and ANTHRACURE UVS-1221 (manufactured by Kawasaki Kasei Chemicals Co., Ltd.). The content of the photosensitizer(s) is preferably from 0.1 to 5% by weight, more preferably from 0.5 to 3% by weight.

### <Other Components>

The curing type adhesive composition according to the present invention preferably contains the following components.

### <Acryl-Based Oligomer (A)>

The active energy curing type adhesive composition according to the present invention may contain, besides the above-mentioned curable component related to a radical polymerizable compound, an acryl-based oligomer (A) yielded by polymerizing a (meth)acrylic monomer. By incorporating the component (A) into the active energy ray curing type adhesive composition, the composition can be decreased in cure shrinkage when irradiated with an active energy ray and cured, and further the resultant adhesive can be decreased in interface stress to adherends such as a polarizer and a transparent protective film. As a result, the adhesive layer and the adherends can be restrained from being lowered in adhesion. In order to restrain the cure shrinkage of the cured product layer (adhesive layer), the content of the acryl-based oligomer (A) is preferably 20 parts or less by weight, more preferably 15 parts or less by weight for 100 parts by weight of the whole of the curable component. If the content of the acryl-based oligomer (A) is too large in the adhesive composition, the composition is seriously lowered in reaction rate when irradiated with an active energy ray, so that the composition may be insufficiently cured. In the meantime, the composition contains the acryl-based oligomer (A) in an amount that is preferably 3 parts or more, more preferably 5 parts or more by weight for 100 parts by weight of the whole of the curable component.

The active energy ray curing type adhesive composition is preferably low in viscosity, considering the workability and evenness of the composition when the composition is painted. Thus, the acryl-based oligomer (A) yielded by polymerizing a (meth)acrylic monomer is also preferably low in viscosity. About an acryl-based oligomer (A) which is low in viscosity and can prevent the cure shrinkage of the adhesive layer, the weight-average molecular weight (Mw) thereof is preferably 15000 or less, more preferably 10000 or less, in particular preferably 5000 or less. In the meantime, the weight-average molecular weight (Mw) of the acryl-based oligomer (A) is preferably 500 or more, more preferably 1000 or more, in particular preferably 1500 or more to restrain the cured product layer (adhesive layer) sufficiently from undergoing cure shrinkage. Specific examples of the (meth)acrylic monomer, from which the acryl-based oligomer (A) is produced, include methyl (meth)acrylate, ethyl (meth)acrylate, n-propyl (meth)acrylate, isopropyl (meth)acrylate, 2-methyl-2-nitro-propyl (meth)acrylate, n-butyl (meth)acrylate, isobutyl (meth)acrylate, S-butyl (meth)acrylate, t-butyl (meth)acrylate, n-pentyl (meth)acrylate, t-pentyl (meth)acrylate, 3-pentyl (meth)acrylate, 2,2-dimethylbutyl (meth)acrylate, n-hexyl (meth)acrylate, cetyl (meth)acrylate, n-octyl (meth)acrylate, 2-ethylhexyl (meth)acrylate, 4-methyl-2-propylpentyl (meth)acrylate, N-octadecyl (meth)acrylate and other (1-20 carbon-atom) alkyl esters of (meth)acrylic acid, cycloalkyl (meth)acrylates (such as cyclohexyl (meth)acrylate, and cyclopentyl (meth)acrylate), aralkyl (meth)acrylates (such as benzyl (meth)acrylate), polycyclic (meth)acrylate (such as 2-isobornyl (meth)acrylate, 2-norbornylmethyl (meth)acrylate, 5-norbornene-2-yl-methyl (meth)acrylate, and 3-methyl-2-norbornylmethyl (meth)acrylate), hydroxyl-group-containing (meth)acrylates (such as hydroxylethyl (meth)acrylate, 2-hydroxypropyl (meth)acrylate, and 2,3-dihydroxypropylmethyl-butyl (meth)acrylate, alkoxy-group- or phenoxy-group-containing (meth)acrylates (such as 2-methoxyethyl (meth)acrylate, 2-ethoxyethyl (meth)acrylate, 2-methoxymethoxyethyl (meth)acrylate, 3-methoxybutyl (meth)acrylate, ethylcarbitol (meth)acrylate, and phenoxyethyl (meth)acrylate), epoxy-group-containing (meth)acrylates (such as glycidyl (meth)acrylate), halogen-containing (meth)acrylates (such as 2,2,2-trifluoroethyl (meth)acrylate, 2,2,2-trifluoroethylethyl (meth)acrylate, tetrafluoropropyl (meth)acrylate, hexafluoropropyl (meth)acrylate, octafluoropentyl (meth)acrylate, heptadecafluorodecyl (meth)acrylate), and alkylaminoalkyl (meth)acrylates (such as dimethylaminoethyl (meth)acrylate). These (meth)acrylates can be used singly or in combination of two or more thereof. Specific examples of the acryl-based oligomer (A) include products “ARUFON” manufactured by Toagosei Co., Ltd., “ACTFLOW” manufactured by Soken Chemical & Engineering Co., Ltd., and “JONCRYL” manufactured by BASF Japan Ltd. Out of acryl-based polymers (A) each yielded by polymerizing a (meth)acrylic monomer, an oligomer high in log Pow value is preferred. The log Pow value of the acryl-based oligomer (A) yielded by polymerizing a (meth)acrylic monomer is preferably 2 or more, more preferably 3 or more, most preferably 4 or more.

### <Optical Acid-Generator (B)>

The active energy ray curing type adhesive composition may contain an optical acid-generator (B). When the active energy ray curing type resin composition contains the optical acid-generator, the resultant adhesive layer can be dramatically made better in water resistance and endurance than when the composition does not contain any optical acid-generator. The optical acid-generator (B) can be represented by the following general formula (3):

L⁺X⁻ [Formula 3]

wherein L⁺ represents any onium cation, and X⁻ represents a counter anion selected from the group consisting of PF6₆⁻, SbF₆⁻, AsF₆⁻, SbCl₆⁻, SnCl₆⁻, ClO₄⁻, a dithiocarbamate anion, and SCN⁻.

Out of these anions, which are given as examples, anions particularly preferred as the counter anion X⁻ in the general formula (3) are PF₆⁻, SbF₆⁻, and AsF₆⁻. PF₆⁻ and SbF₆⁻ are particularly preferred.

Thus, preferred specific examples of the onium salt included in the optical acid-generator (B) in the present invention are “CYRACURE UVI-6992”, and “CYRACURE UVI-6974” (each manufactured by Dow Chemical Japan Ltd.), “ADEKA OPTOMER SP150”, “ADEKA OPTOMER SP152”, “ADEKA OPTOMER SP170”, and “ADEKA OPTOMER SP172” (each manufactured by Adeka Corp.), “IRGACURE 250” (manufactured by Ciba Specialty Chemicals Co., Ltd.), “CI-5102”, and “CI-2855” (each manufactured by Nippon Soda Co., Ltd.), “SAN-AID SI-60L”, “SAN-AID SI-80L”, “SAN-AID SI-100L”, “SAN-AID SI-110L”, and “SAN-AID SI-180L” (each manufactured by Sanshin Chemical Industry Co., Ltd.), “CPI-100P” and “CPI-100A” (each manufactured by San-Apro Ltd.), and “WPI-069”, “WPI-113”, “WPI-116”, “WPI-041”, “WPI-044”, “WPI-054”, “WPI-055”, “WPAG-281”, “WPAG-567”, and “WPAG-596” (each manufactured by Wako Pure Chemical Industries, Ltd.).

The content of the optical acid-generator (B) is 10 parts or less, preferably from 0.01 to 10 parts, more preferably from 0.05 to 5 parts, in particular preferably from 0.1 to 3 parts by weight for 100 parts by weight of the whole of the curable component(s).

### <Compound (C) Containing Either Alkoxy Group or Epoxy Group>

In the active energy ray curing type adhesive composition, the optical acid-generator (B) may be used together with a compound (C) containing either an alkoxy group or an epoxy group.

### (Compound and Polymer Each Having Epoxy Group) (C)

In the use of using a compound having in the molecule thereof one or more epoxy groups, or a polymer having in the molecule thereof two or more epoxy groups (epoxy resin), a compound may be together used which has in the molecule thereof two or more functional groups having reactivity with the epoxy group(s). Examples of the functional groups having reactivity with the epoxy group(s) include carboxyl groups, phenolic hydroxyl groups, mercapto groups, and primary or secondary aromatic amino groups. It is particularly preferred that the compound or polymer has in a single molecule thereof two or more of these functional groups, considering the three-dimensional curability.

Examples of the polymer having in the molecule one or more epoxy groups include bisphenol A type epoxy resin derived from bisphenol A and epichlorohydrin, bisphenol F type epoxy resin derived from bisphenol F and epichlorohydrin, bisphenol S type epoxy resin, phenol novolak type epoxy resin, cresol novolak type epoxy resin, bisphenol A novolac type epoxy resin, bisphenol F novolak type epoxy resin, alicyclic epoxy resins, diphenyl ether type epoxy resins, hydroquinone type epoxy resins, naphthalene type epoxy resins, biphenyl type epoxy resins, fluorene type epoxy resins, polyfunctional epoxy resins such as trifunctional epoxy resins and tetrafunctional epoxy resins, glycidylester type epoxy resins, glycidylamine type epoxy resins, hydantoin type epoxy resins, isocyanurate type epoxy resins, and linear aliphatic epoxy resin. These epoxy resins may be halogenated, or hydrogenated. Examples of commercially available epoxy resin products include products JERCOATs 828, 1001, 801N, 806, 807, 152, 604, 630, 871, YX 8000, YX 8034, and YX 4000 manufactured by Japan Epoxy Resins Co., EPICHLONs 830, EXA 835LV, HP 4032D, and HP 820 manufactured by DIC Corp., EP 4100 series, EP4000 series, and EPU series manufactured by Adeka Corp., CELLOXIDE series (2021, 2021P, 2083, 2085, and 3000), EPOLEAD series, and EHPE series, manufactured by Daicel Corp., YD series, YDF Series, YDCN series, YDB series, phenoxy resins (for example, YP series: polyhydroxy polyethers each synthesized from a bisphenol and epichlorohydrin, and each having, at both terminals thereof, epoxy groups, respectively) manufactured by Nippon Steel Chemical Co., Ltd., DENACOL series manufactured by Nagase ChemteX Corp., EPOLIGHT series manufactured by Kyoeisha Chemical Co., Ltd. However, the epoxy resin products are not limited to these examples. These epoxy resins may be used in combination of two or more thereof. When the glass transition temperature Tg of the adhesive layer is calculated, the compound and polymer (C) each having an epoxy group are not considered for the calculation.

(Compound and Polymer Each Having Alkoxyl Group) (C) The compound having in the molecule thereof an alkoxyl group is not particularly limited as far as the compound is a compound having in the molecule thereof one or more alkoxyl groups. The compound may be a known compound. Typical examples of such a compound include melamine compounds, amino resins, and silane coupling agents. When the glass transition temperature Tg of the adhesive layer is calculated, the compound and polymer (C) each having an alkoxyl group are not considered for the calculation.

The blend amount of the compound (C) having either an alkoxy group or an epoxy group is usually 30 parts or less by weight for 100 parts by weight of the whole of curable component(s). If the content of the compound (C) in the composition is too large, the resultant adhesive layer may be lowered in adhesive performance, and may be deteriorated, in a drop test, impact resistance. The content of the compound (C) in the composition is more preferably 20 parts or less by weight. In the meantime, the composition contains the compound (C) in an amount that is preferably 2 parts or more, more preferably 5 parts or more from the viewpoint of the water resistance.

### <Silane Coupling Agent (D)>

When the curing type adhesive composition of the present invention for polarizing film is of an active energy ray curable curing type, an active energy ray curable compound is preferably used as the silane coupling agent (D). However, even when the silane coupling agent (D) is not active energy ray curable, the silane coupling agent (D) can give the composition substantially the same water resistance.

Specific examples of the silane coupling agent (D) that is an active energy ray curable compound include vinyltrichlorosilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, and 3-acryloxypropyltrimethoxysilane.

The silane coupling agent (D) is preferably 3-methacryloxypropyltrimethoxysilane, or 3-acryloxypropyltrimethoxysilane.

A specific example of the silane coupling agent that is not an active energy ray curable is preferably a silane coupling agent (D1) having an amino group. Specific examples of the silane coupling agent (D1) having an amino group include γ-aminopropyltrimethoxysilane, γ-aminopropyltriethoxysilane, γ-aminopropyltriisopropoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-(2-aminoethyl)aminopropyltriisopropoxysilane, γ-(2-(2-aminoethyl)aminoethyl)aminopropyltrimethoxysilane, γ-(6-aminohexyl)aminopropyltrimethoxysilane, 3-(N-ethylamino)-2-methylpropyltrimethoxysilane, γ-ureidopropyltrimethoxysilane, γ-ureidopropyltriethoxysilane, N-phenyl-γ-aminopropyltrimethoxysilane, N-benzyl-γ-aminopropyltrimethoxysilane, N-vinylbenzyl-γ-aminopropyltriethoxysilane, N-cyclohexylaminomethyltriethoxysilane, N-cyclohexylaminomethyldiethoxymethylsilane, N-phenylaminomethyltrimethoxysilane, (2-aminoethyl) aminomethyltrimethoxysilane, N,N′-bis[3-(trimethoxysilyl)propyl]ethylenediamine, and other amino-group-containing silanes; N-(1,3-dimethylbutylidene)-3-(triethoxysilyl)-1-propanamine, and other ketimine type silanes.

Silane coupling agents (D1) each having an amino group may be used singly or in any combination of two or more thereof. in order that the adhesive composition may ensure a good adhesive performance, out of these silane coupling agents, preferred are γ-aminopropyltrimethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, and N-(1,3-dimethylbutylidene)-3-(triethoxysilyl)-1-propanamine

The blend amount of the silane coupling agent(s) (D) ranges preferably from 0.01 to 20 parts, preferably from 0.05 to 15 parts, more preferably from 0.1 to 10 parts by weight for 100 parts by weight of the whole of the curable component(s). If the blend amount is more than 20 parts by weight, the adhesive composition is deteriorated in storage stability. If the amount is less than 0.1 part by weight, the composition does not exhibit adhesion water resistance effect sufficiently. When the glass transition temperature Tg of the adhesive layer is calculated, the silane coupling agent(s) (D) is/are not considered for the calculation.

Specific examples of the silane coupling agent that is not active energy ray curable include, besides the above-mentioned examples, 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl) tetrasulfide, 3-isocyanatopropyltriethoxysilane, and imidazolesilane.

### <Compound (E) Having Vinyl Ether Group>

When the curing type adhesive composition of the present invention for polarizing film contains a compound (E) having a vinyl ether group, the resultant adhesive layer and a polarizer are favorably improved in adhesion water resistance therebetween. Reasons that this advantageous effect is gained are unclear; however, the following is supposed to be one of the reasons: the vinyl ether group which the compound (E) has interacts with the polarizer, thereby heightening the adhering strength between the polarizer and the adhesive layer. In order to heighten the adhesion water resistance further between the polarizer and the adhesive layer, the compound (E) is preferably a radical polymerizable compound having a vinyl ether group. The content of the compound (E) is preferably from 0.1 to 19 parts by weight for 100 parts by weight of the curable component(s).

<Compound (F) in which Keto-Enol Tautomeric is Generated>

The curing type adhesive composition of the present invention for polarizing film may contain a compound in which keto-enol tautomeric is generated. For the adhesive composition which contains a crosslinking agent, or for the adhesive composition usable in the state that a crosslinking agent is blended into the composition, an embodiment is preferably adoptable which contains the compound in which keto-enol tautomeric is generated. This embodiment makes it possible to restrain an excessive rise of the adhesive composition in viscosity, the gelatinization thereof, and the production of a micro gelatinized product after the organometallic compound is blended into the composition. Consequently, the adhesive composition can realize an advantageous effect of prolonging the pot life of the composition.

The compound (F) in which keto-enol tautomeric is generated may be a β-dicarbonyl compound that may be of various types. Specific examples thereof include acetylacetone, 2,4-hexanedione, 3,5-heptanedione, 2-methylhexane-3,5-dione, 6-methylheptane-2,4-dione, 2,6-dimethylheptane-3,5-dione, and other β-diketones; methyl acetoacetate, ethyl acetoacetate, isopropyl acetoacetate, tert-butyl acetoacetate, and other acetoacetates; ethyl propionylacetate, ethyl propionylacetate, isopropyl propionylacetate, tert-butyl propionylacetate, and other propionylacetates; ethyl isobutyrylacetate, ethyl isobutyrylacetate, isopropyl isobutyrylacetate, tert-butyl isobutyrylacetates, and other isobutyrylacetates; methyl malonate, ethyl malonate, and other malonates. Out of these compounds, preferred compounds are acetylacetone and acetoacetates. Such compounds (F) in each of which keto-enol tautomeric is generated may be used singly or in any combination of two or more thereof.

The use amount of the compound(s) in which keto-enol tautomeric is generated may be, for example, from 0.05 to 10 parts, preferably from 0.2 to 3 parts (for example, from 0.3 to 2 parts) by weight for one part by weight of the organometallic compound. If the use amount of the compound(s) is less than 0.05 part by weight for one part by weight of the organometallic compound, a sufficient advantageous effect based on the use thereof may not be easily exhibited. In the meantime, if the use amount of the compound(s) is more than 10 parts by weight for one part by weight of the organometallic compound, the compound(s) may interact excessively with the organometallic compound not to produce a target water resistance easily.

<Additives Other than Above-Mentioned Components>

As far as the objects and the advantageous effects of the present invention are not damaged, various additives may be blended, as other optional components, into the curing type adhesive composition of the present invention for polarizing film. Examples of the additives include epoxy resins, polyamides, polyamideimides, polyurethanes, polybutadienes, polychloroprenes, polyethers, polyesters, styrene-butadiene block copolymers, petroleum resins, xylene resins, ketone resins, cellulose resins, fluorine-containing oligomers, silicone-based oligomers, polysulfide-based oligomers, and other polymers or oligomers; phenothiazine, 2,6-di-t-butyl-4-methylphenol, and other polymerization inhibitors; polymerization initiation aids; leveling agents; wettability improvers; surfactants; plasticizers; ultraviolet absorbers; inorganic fillers; pigments; and dyes. Out of such various additives, additives high in log Pow value are preferred. The log Pow value of the various additives is preferably 2 or more, more preferably 3 or more, most preferably 4 or more.

The amount of the additives is usually from 0 to 10 parts, preferably from 0 to 5 parts, most preferably from 0 to 3 parts by weight for 100 parts by weight of the whole of the curable component(s).

### <Viscosity of Adhesive Composition>

The curing type adhesive composition of the present invention for polarizing film include the above-mentioned curable component(s); the viscosity of the adhesive composition is 100 cp or less at 25° C. from the viewpoint of the paintability of the composition. If the curing type adhesive composition of the invention for polarizing film is more than 100 cp at 25° C., the temperature of the adhesive composition is controlled when the composition is painted, whereby the composition is usable in the state of adjusting the viscosity thereof to 100 cp or less. The viscosity ranges more preferably from 1 to 80 cp, most preferably from 10 to 50 cp. The viscosity is measurable, nisi rig an R-type viscometer TVE22LT manufactured by Toki Sangyo Co., Ltd.

In the curing type adhesive composition of the present invention for polarizing film, a material low in skin irritation is preferably used as the curable component from the viewpoint of safety. The skin irritation can be estimated in accordance with an index called P.I.I. The P.I.I. is widely used as an index showing the degree of skin disorder, and is measured by a Draize test. Any measured value thereof is represented in the range of 0 to 8. As the value of a material is smaller, the material is estimated to be low in skin irritation. The measured value is large in accidental error; thus, it is advisable to understand this value as a reference value. The P.I.I. is preferably 4 or less, more preferably 3 or less, even more preferably 2 or less.

The curing type adhesive composition according to the present invention for polarizing film can be manufactured by a manufacturing method having a first mixing step of mixing an active energy ray curable component (X) with a polymerizable compound (B) having a polymerizable functional group and a carboxyl group to yield a mixed curable component, and a second mixing step of mixing the mixed curable component with at least one organometallic compound (A) selected from the group consisting of a metal alkoxide and a metal chelate. Any component other than the components (X), (A) and (B) may be incorporated into the manufacturing method at any stage in the first and second mixing steps.

Furthermore, the curing type adhesive composition according to the present invention for polarizing film can be manufactured by a manufacturing method having a first mixing step of mixing at least one organometallic compound (A) selected from the group consisting of a metal alkoxide and a metal chelate with a polymerizable compound (B) having a polymerizable functional group and a carboxyl group to yield an organometallic-compound-including composition, and a second mixing step of mixing the organometallic-compound-including composition with an active energy ray curable component. This manufacturing method makes the organometallic compound (A) dramatically high in stability in the organometallic-compound-including composition to heighten favorably the stability of the curing type adhesive composition for polarizing film in the same manner. Any component other than the components (X), (A) and (B) may be incorporated into the manufacturing method at any stage in the first and second mixing steps. However, the incorporation of the other component is attained preferably after the first mixing step to heighten the reaction rate and/or the coordination rate between the organometallic compound (A) and the polymerizable compound (B), and improve the organometallic compound in stability.

### <Bulk Water Absorption>

In the case of immersing a cured product yielded by curing the curing type adhesive composition of the present invention for polarizing film in pure water of 23° C. temperature for 24 hours, the measured bulk water absorption of the product is preferably 10% or less by weight. When a polarizing film is put in a severely high temperature and high humidity (for example, 85° C. and 85% RH) environment, water transmitted through its transparent protective film and adhesive layer invades its polarizer, so that a crosslinked structure of the polarizer is hydrolyzed. In this way, the orientation of the dichroic dye is disturbed so that the polarizer suffers from deteriorations in optical endurances, such as a rise in transmittance and a fall in polarization degree. By setting the bulk water absorption of the adhesive layer to 10% or less by weight, the shift of water into the polarizer is restrained when the polarizing film is put in a severely high temperature and high humidity environment; consequently, the polarizer can be restrained from rising in transmittance and falling in polarization degree. The bulk water absorption is preferably 5% or less by weight, more preferably 3% or less by weight, most preferably 1% or less by weight to make the adhesive layer of the polarizing film better in optical endurances in the severely high temperature environment. In the meantime, when the polarizer and the transparent protective film are bonded to each other, the polarizer keeps a constant quantity of water. Thus, when waters contained, respectively, in the curing type adhesive composition and in the polarizer contact each other, the polarizing film may undergo external appearance defects such as repellence and air bubbles. In order to restrain the external appearance defects, it is preferred that the curing type adhesive composition can absorb a predetermined amount of water. More specifically, the bulk water absorption is preferably 0.01% or more by weight, more preferably 0.05% or more by weight. The bulk water absorption is measured specifically by a water absorption testing method described in JIS K 7209.

### <Cure Shrinkage>

The curing type adhesive composition of the present invention for polarizing film has the above-mentioned curable component; thus, when the curing type adhesive composition is cured, the composition usually suffers from cure shrinkage. The factor of the cure shrinkage is an index showing the proportion of the cure shrinkage generated when an adhesive layer is formed to include the curing type adhesive composition for polarizing film. It is preferred that the cure shrinkage factor of the adhesive layer becomes large for the restraint of the following: an interfacial strain is generated when the curing type adhesive composition for polarizing film is cured to form the adhesive layer; consequently, the polarizing film undergoes adhesive failure. From the viewpoint of this restraint, about the cured product yielded by curing the curing type adhesive composition of the invention for polarizing film, the cure shrinkage factor is preferably 10% or less. It is preferred that the cure shrinkage factor is small. The cure shrinkage factor is preferably 8% or less, more preferably 5% or less. The cure shrinkage factor is measured by a method described in JP-A-2013-104869, and is measured specifically by a method using a cure shrinkage sensor manufactured by Sentec Co., Ltd.

### <Polarizing Film>

The polarizing film of the present invention includes a polarizer, and a transparent protective film bonded to at least one surface of the polarizer to interpose, between the film and the surface, an adhesive layer formed to include a layer of a cured product of the above-defined curing type adhesive composition for polarizing film. As described above, the adhesive layer, which is the cured product layer, has a bulk water absorption of 10% or less by weight.

### <Adhesive Layer>

The thickness of an adhesive layer formed to include the curing type adhesive composition is controlled into a range preferably from 0.1 to 3 μm. The thickness of the adhesive layer ranges more preferably from 0.3 to 2 μm, even more preferably from 0.5 to 1.5 μm. By setting the thickness of the adhesive layer to 0.1 μm or more, the following can be favorably restrained: adhesive failure is generated by cohesive force of the adhesive layer; and when the members concerned are laminated onto each other, an external appearance defect (air bubbles) is generated. If the thickness of the adhesive layer is larger than 3 μm, the polarizing film may not unfavorably satisfy endurance.

The curing type adhesive composition is selected to set the Tg of an adhesive layer formed to include this composition preferably to 60° C. or higher, more preferably 70° C. or higher, even more preferably 75° C. or higher, even more preferably 100° C. or higher, even more preferably 120° C. or higher. If the Tg of the adhesive layer becomes too high, the polarizing film is lowered in bendability. Thus, the Tg of the adhesive layer is preferably 300° C. or lower, more preferably 240° C. or lower, even more preferably 180° C. or lower. The Tg<glass transition temperature> is measured under conditions described below, using a dynamic viscoelasticity measuring instrument RSAIII manufactured by a company TA Instruments.

Sample size: 10 mm in width and 30 mm in length,

Clamp distance: 20 mm,

Measuring mode: tension, frequency: 1 Hz, and temperature-raising rate: 5° C./minute. The dynamic viscoelasticity of a sample is measured, and the temperature of a peak top of the tan δ thereof is adopted as the Tg.

About the curing type adhesive composition, the storage modulus of an adhesive layer formed using this composition is preferably 1.0×10⁷ Pa or more, more preferably 1.0×10⁸ Pa or more at 25° C. The storage modulus of the pressure-sensitive adhesive layer is from 1.0×10³ to 1.0×10⁶ Pa, and is different from the storage modulus of the adhesive layer. When the polarizing film is subjected to heat cycles (for example, cycles from −40 to 80° C.), the storage modulus of the adhesive layer affects cracking of the polarizer. When the storage modulus is low, inconveniences are easily generated about the polarizer cracking. A temperature range in which the adhesive layer has a high storage modulus is preferably 80° C. or lower, most preferably 90° C. or lower. At the same time of measuring the Tg<glass transition temperature>, the storage modulus is measured under the same conditions, using the dynamic viscoelasticity measuring instrument RSAIII manufactured by a company TA Instruments. The dynamic viscoelasticity of a sample is measured to adopt the value of the storage modulus (E′) thereof.

The polarizing film according to the present invention can be manufactured by the following manufacturing method:

A manufacturing method including an applying step of applying a curing type adhesive composition for polarizing film to a surface of at least one of a polarizer and a transparent protective film; a bonding step of causing the polarizer and the transparent protective film to bond to each other; and an adhering step of radiating an active energy ray to the resultant bonded body from the polarizer surface side thereof, or the transparent protective film surface side thereof to cure the active energy ray curing type adhesive composition, and thereby adhering, through the resultant adhesive layer, the polarizer and the transparent protective film to each other. In this manufacturing method, the water content by percentage of the polarizer is preferably from 8 to 19% in the bonding step.

Before the applying of the curing type adhesive composition, the polarizer and the transparent protective film may be subjected to a surfaced modifying treatment. Specific examples of the treatment include corona treatment, plasma treatment, and saponifying treatment.

An applying means for the curing type adhesive composition is appropriately selected in accordance with the viscosity of the composition and a target thickness of the resultant. The applying means may be, for example, a reverse coater, gravure coater (direct, reverse or offset coater), bar reverse coater, roll coater, die coater, bar coater, or rod coater. Furthermore, for the application, a dipping manner or some other manner is appropriately usable.

The polarizer and the transparent protective film are caused to bond to each other to interpose, therebetween, the curing type adhesive composition applied as described above. The bonding of the polarizer and the transparent protective film to each other can be attained, using, for example, a roll laminator.

### <Curing of Adhesive Composition>

The curing type adhesive composition for polarizing film according to the present invention is used as an active energy ray curing type adhesive composition. The active energy ray curing type adhesive composition is usable in an electron beam curing type, ultraviolet-ray curing type or visible ray curing type form. The form of the curing type adhesive composition is preferably a visible ray curing type adhesive composition from the viewpoint of the producibility thereof.

### <<Active Energy Ray Curing Type>>

About the active energy ray curing type adhesive composition, a polarizer and a transparent protective film are caused to bond to each other, and subsequently the resultant bonded body is irradiated with an active energy ray (such as an electron beam, an ultraviolet ray or a visible ray) to cure the active energy ray curing type adhesive composition, thereby forming an adhesive layer. A direction along which the active energy ray (which is, for example, an electron beam, an ultraviolet ray or a visible ray) is radiated may be any appropriate radiating direction. Preferably, the active energy ray is radiated from the transparent protective film side of the bonded body. If the active energy ray is radiated from the polarizer side thereof, the polarizer may be unfavorably deteriorated by the active energy ray (which is, for example, an electron beam, an ultraviolet ray or a visible ray).

### <<Electron Beam Curing Type>>

About the electron beam curing type form, conditions for radiating the electron beam may be arbitrarily-selected appropriate conditions as far as the conditions are conditions under which the active energy ray curing type adhesive composition is curable. About the electron beam radiation, for example, the accelerating voltage is preferably from 5 to 300 kV, more preferably from 10 to 250 kV. If the accelerating voltage is less than 5 kV, the electron beam may not reach the adhesive so that the adhesive may not be unfavorably cured sufficiently. If the accelerating voltage is more than 300 kV, the penetrating power of the beam into a sample is too strong, so that the beam may unfavorably damage its transparent protective film or polarizer. The radiation quantity thereof is from 5 to 100 kGy, more preferably from 10 to 75 kGy. If the radiation quantity is less than 5 kGy, the adhesive is insufficiently cured. If the quantity is more than 100 kGy, the transparent protective film or the polarizer is damaged, so that the polarizing film is lowered in mechanical strength or yellowed not to gain predetermined optical properties.

The electron beam radiation is usually performed in an inert gas. If necessary, the radiation may be performed in the atmospheric air or under conditions that a small amount of oxygen is introduced into an inert gas. An appropriate introduction of oxygen dares to cause oxygen blocking in a surface of the transparent protective film onto which the electron beam is initially radiated, so that the beam can be prevented from damaging the transparent protective film to radiate the electron beam effectively only to the adhesive although this matter depends on the material of the transparent protective film.

### <<Ultraviolet-Ray Curing Type and Visible Ray Curing Type>>

In the method according to the present invention for manufacturing a polarizing film, it is preferred to use, as active energy rays, rays including visible rays having wavelengths ranging from 380 to 450 nm, particularly, active energy rays in which the radiation quantity of visible rays having wavelengths ranging from 380 to 950 nm is largest. When a transparent protective film to which ultraviolet ray absorbing power is given (ultraviolet non-transmissible type transparent protective film) is used in the ultraviolet-ray curing type or visible ray curing type form, the transparent protective film absorbs light rays having wavelengths shorter than about 380 nm; thus, the light rays having wavelengths shorter than 380 nm do not reach the active energy ray curing type adhesive composition not to contribute to a polymerization reaction of the composition. Furthermore, the light rays having wavelengths shorter than 380 nm, which are absorbed by the transparent protective film, are converted to heat, so that the transparent protective film itself generates heat. The heat causes defects of the polarizing film, such as a curling or wrinkles of the film. Thus, in the case of adopting, in the invention, the ultraviolet-ray curing type or visible ray curing type form, it is preferred to use, as an active energy ray generating device, a device which does not emit light rays shorter than 380 nm. More specifically, such a device is a device in which the ratio of the cumulative illuminance of light rays having a wavelength range from 380 to 440 nm to that of light rays having a wavelength range from 250 to 370 nm is preferably from 100/0 to 100/50, more preferably from 100/0 to 100/40. For the active energy ray related to the present invention, preferred is a gallium sealed metal halide lamp, or an LED light source emitting light rays having a wavelength range from 380 to 440 nm. Alternatively, a light source including ultraviolet rays and visible rays is usable, examples of which include a low pressure mercury lamp, a middle pressure mercury lamp, a high pressure mercury lamp, a super high pressure mercury lamp, an incandescent lamp, a xenon lamp, a halogen lamp, a carbon arc lamp, a metal halide lamp, a fluorescent lamp, a tungsten lamp, a gallium lamp, an excimer laser, and sunlight. It is allowable to use light rays about which a bandpass filter is used to block ultraviolet rays having wavelengths shorter than 380 nm. In order to heighten the adhesive performance of the adhesive layer between the polarizer and the transparent protective film, and simultaneously prevent the polarizing film from being curled, it is preferred to use an active energy ray obtained by using a gallium sealed metal halide lamp and further passing light therefrom through a bandpass filter which can block light rays having wavelengths shorter than 380 nm, or an active energy ray having a wavelength of 905 nm, which is obtained by using an LED light source.

About the ultraviolet-ray curing type or visible ray curing ray type form, it is preferred to heat the active energy ray curing type adhesive composition before the radiation of ultraviolet rays or visible rays (heating before radiation). In this case, the composition is heated preferably to 40° C. or higher, more preferably to 50° C. or higher. It is also preferred to heat the active energy ray curing type adhesive composition after the radiation of ultraviolet rays or visible rays (heating after radiation). In this case, the composition is heated preferably to 40° C. or higher, more preferably to 50° C. or higher.

The active energy ray curing type adhesive composition according to the present invention is favorably usable, particularly, when an adhesive layer is formed for adhering a polarizer to a transparent protective film about which the transmittance of light rays having a wavelength of 365 nm is less than 5%. In this case, the active energy ray curing type adhesive composition according to the invention includes a photopolymerization initiator of the general formula (1), so that the composition is irradiated with ultraviolet rays across the transparent protective film having UV absorbing power. Consequently, the composition can be cured to form an adhesive layer. Thus, also in a polarizing film in which transparent protective films having UV absorbing power are laminated, respectively, onto two surfaces of a polarizer, its adhesive layer can be cured. Naturally, however, also in a polarizing film in which a transparent protective film having no UV absorbing power is laminated, its adhesive layer can be cured. The wording “transparent protective film having UV absorbing power” means a transparent protective film about which the transmittance of a light ray having a wavelength of 380 nm is less than 10%.

The method for giving UV absorbing power to a transparent protective film may be a method of incorporating an ultraviolet absorbent into the transparent protective film, or a method of laminating a surface treatment layer containing an ultraviolet absorbent onto a surface of the transparent protective film.

Specific examples of the ultraviolet absorbent include oxybenzophenone-based compounds, benzotriazole-based compounds, salicylate-based compounds, benzophenone-based compounds, cyanoacrylate-based compounds, nickel complex salt type compounds, and triazine-based compounds, which are known in the prior art.

After the polarizer and the transparent protective film are caused to bond to each other, the active energy ray curing type adhesive composition is irradiated with an active energy ray (such as an electron beam, an ultraviolet ray or a visible ray) to be cured to form an adhesive layer. A direction along which the active energy ray (which is, for example, an electron beam, an ultraviolet ray or a visible ray) is radiated may be any appropriate radiating direction. Preferably, the active energy ray is radiated from the transparent protective film side of the bonded body. If the active energy ray is radiated from the polarizer side thereof, the polarizer may be unfavorably deteriorated by the active energy ray (which is, for example, an electron beam, an ultraviolet ray or a visible ray).

When the polarizing film according to the present invention is manufactured in a continuous line, the line speed, which depends on the curing period of the adhesive composition, is preferably from 1 to 500 m/min., more preferably from 5 to 300 m/min., even more preferably from 10 to 100 m/min. If the line speed is too small, the manufacturing system is small in productivity, or the transparent protective film is excessively damaged so that a polarizing film which can endure an endurance test cannot be manufactured. If the line speed is too large, the adhesive composition is insufficiently cured so that the composition may not gain a target adhesive performance.

In the polarizing film of the present invention, a polarizer and a transparent protective film are caused to bond to each other to interpose, therebetween, an adhesive layer formed to include a layer of a cured product of the above-defined active energy ray curing type adhesive composition. Between the transparent protective film and the adhesive layer, an easily adhesive layer may be disposed. The easily adhesive layer can be formed, using a resin that may be of various types. This resin has, for example, a polyester, polyether, polycarbonate, polyurethane, polyamide, polyimide or polyvinyl alcohol skeleton, or is, for example, of a silicone type. These polymeric resins may be used singly or in any combination of two or more thereof. In the formation of the easily adhesive layer, a different additive may be added thereto. Specifically, for example, the following may be used: a tackifier, an ultraviolet absorbent, an antioxidant, or a stabilizer such as a heat-resisting stabilizer.

The easily adhesive layer is usually laid on the transparent protective film in advance, and the easily adhesive layer side of the transparent protective film and the polarizer are caused to bond to each other to interpose, therebetween, the adhesive layer. The formation of the easily adhesive layer is attained by painting a material for forming the easily adhesive layer onto the transparent protective film, and then drying the resultant according to a known technique. The material for forming the easily adhesive layer is usually prepared in the form of a solution in which the concentration of the material is diluted into an appropriate concentration, considering the thickness of the material-dried layer, the smoothness of the painting, and others. The thickness of the dried easily adhesive layer is preferably from 0.01 to 5 μm, more preferably from 0.02 to 2 μm, even more preferably from 0.05 to 1 μm. Plural easily adhesive layers may be laid. In this case also, however, the total thickness of the easily adhesive layers is set preferably into any one of these ranges.

### <Polarizer>

The polarizer is not particularly limited, and may be of various types. The polarizer is, for example, a polarizer yielded by causing a dichroic material such as iodine or dichroic dye to be adsorbed into a hydrophilic polymeric film, such as a polyvinyl alcohol-based film, a partially-formal-converted polyvinyl alcohol-based film or an ethylene/vinyl acetate copolymer-based partially saponified film, and then drawing the resultant monoaxially; or a polyene aligned film made of, for example, a polyvinyl alcohol dehydrated product or a polyvinyl de-hydrochloride-treated product. Out of such polarizers, preferred is a polarizer composed of a polyvinyl alcohol-based film and a dichroic substance such as iodine. The thickness of such a polarizer is not particularly limited, and is generally about 80 μm or less.

The polarizer in which a polyvinyl alcohol-based film dyed with iodine has monoaxially drawn can be produced, for example, by immersing a polyvinyl alcohol into an aqueous solution of iodine to be dyed, and then drawing the resultant film into a length 3 to 7 times the original length of this film. As required, the drawn film may be immersed into an aqueous solution of, for example, boric acid or potassium iodide. Furthermore, before the dyeing, the polyvinyl alcohol-based film may be immersed into water as required to be cleaned with water. The cleaning of the polyvinyl alcohol-based film with water makes it possible to clean stains and a blocking-preventing agent on surfaces of the polyvinyl alcohol-based film, and further produce an advantageous effect of swelling the polyvinyl alcohol-based film to prevent unevenness of the dyeing, and other unevennesses. The drawing may be performed after the dyeing with iodine or while the dyeing is performed. Alternatively, after the drawing, the dyeing with iodine may be performed. The drawing may be performed in an aqueous solution of, for example, boric acid or potassium iodide, or in a water bath.

When a thin polarizer having a thickness of 10 μm or less is used as the polarizer, the curing type adhesive composition of the present invention can remarkably produce the advantageous effect thereof (that the resultant adhesive layer satisfies optical endurance in a severe environment at a high temperature and high humidity). The polarizer having, the thickens of which is 10 μm or less, is more largely affected by water than any polarizer having a thickness more than 10 μm, so that the former is insufficient in optical endurance in an environment at a high temperature and high humidity to be easily raised in transmittance or lowered in polarization degree. Accordingly, in the case of laminating the polarizer, the thickness of which is 10 μm or less, onto a transparent protective film to interpose, therebetween, an adhesive layer that is made of a cured product of the curing type adhesive composition according to the invention for polarizing film, which contains at least one organometallic compound selected from the group consisting of a metal alkoxide and a metal chelate, and that further has a bulk water absorption of 10% or less by weight, the shift of water into the polarizer is restrained in a severely high temperature and high humidity environment. Consequently, the polarizing film can be remarkably restrained from undergoing deteriorations in optical endurances, such as a rise in transmittance and a lowering in polarization degree. The thickness of the polarizer is preferably from 1 to 7 μm from the viewpoint of making the polarizer thinner. Such a thin polarizer is small in thickness unevenness, excellent in perceptibility, and small in dimension change. Furthermore, favorably, this thin polarizer also makes the resultant polarizing film small in thickness.

Typical examples of the thin polarizer include thin polarizing membranes described in JP-A-S51-069644, JP-A-2000-338329, WO 2010/100917 pamphlet, and specifications of PCT/JP2010/001460 and Japanese Patent Applications No. 2010-269002 and No. 2010-263692. These thin polarizing membranes can each be yielded by a producing method including the step of drawing a polyvinyl alcohol-based resin (hereinafter referred to also as a PVA-based resin) and a resin substrate for drawing in a laminate state, and the step of dyeing the laminate. This producing method makes it possible to draw the laminate, even when the PVA resin layer is thin, without causing any inconvenience, such as breaking by the drawing, on the basis of the supporting of the PVA-based resin layer on the resin substrate for drawing.

The thin polarizing membranes are preferably polarizing membranes each yielded by the following producing method, out of producing methods including the step of dyeing the drawn members concerned in the laminate state and the step of drawing the laminate, since the laminate can be drawn into a large draw ratio to improve the resultant in polarizing performance: a producing method including the step of drawing the laminate in an aqueous solution of boric acid, as is described in a pamphlet of WO 2010/100917, PCT/JP 2010/001460, or Japanese Patent Application No. 2010-269002 or 2010-263692. The membranes are in particular preferably membranes each yielded by a producing method including the step of drawing the laminate supplementally in the air before the drawing in the aqueous solution of boric acid, as is described in Japanese Patent Application No. 2010-269002 or 2010-263692.

### <Transparent Protective Film>

The material which forms the transparent protective film laid over one surface or each of two surfaces of the polarizer is preferably a material excellent in transparency, mechanical strength, thermal stability, water blocking performance, isotropy and others. Examples thereof include polyester-based polymers, such as polyethylene terephthalate and polyethylene naphthalate, cellulose-based polymers such as diacetylcellulose and triacetylcellulose, acryl-based polymers such as polymethyl methacrylate, styrene-based polymers such as polystyrene and acrylonitrile/styrene copolymer (AS resin), and polycarbonate-based polymers. Other examples of the polymer which forms the transparent protective film include polyolefin-based polymers such as polyethylene, polypropylene, polyolefins each having a cyclic or norbornene structure, and ethylene/propylene copolymer, vinyl chloride-based polymers, amide-based polymers such as nylon and aromatic polyamide, imide-based polymers, sulfone-based polymers, polyethersulfone-based polymers, polyetheretherketone-based polymers, polyphenylene sulfide-based polymers, vinyl alcohol-based polymers, vinylidene chloride-based polymers, vinyl butyral-based polymers, arylate-based polymers, polyoxymethylene-based polymers, and epoxy-based polymers; and any blend composed of two or more of these polymers. The transparent protective film may contain one or more additives selected appropriately at will. Examples of the additive(s) include an ultraviolet absorbent, an antioxidant, a lubricant, a plasticizer, a release agent, a coloring preventive, a flame retardant, a nucleating agent, an antistatic agent, a pigment and a colorant. The content of the above-mentioned thermoplastic resins in the transparent protective film is preferably from 50 to 100% by weight, more preferably from 50 to 99% by weight, even more preferably from 60 to 98% by weight, in particular preferably from 70 to 97% by weight. If the content of the thermoplastic resins in the transparent protective film is 50% or less by weight, it is feared that the transparent protective film cannot sufficiently express high transparency and other properties which the thermoplastic resins originally have.

The transparent protective film may be a polymer film described in JP-A-2001-343529 (WO 01/37007), for example, a resin composition including a thermoplastic resin (A) having at a side chain thereof a substituted imide group and/or an unsubstituted imide group and a thermoplastic resin (B) having at aside chain thereof substituted phenyl and/or unsubstituted phenyl, and a nitrile group. A specific example thereof is a film of a resin composition including an alternating copolymer made from isobutylene and N-methylmaleimide, and acrylonitrile/styrene copolymer. The film may be a film made of a blend extruded product of the resin composition. Such a film is small in retardation, and small in photoelastic coefficient; thus, this film can solve inconveniences, such as an unevenness of the polarizing film that is based on strains in the film. Moreover, the film is small in moisture permeability to be excellent in humidity endurance.

In the polarizing film, the transparent protective film preferably has a humidity permeability of 150 g/m²/24-hours or less. This structure makes it difficult that water in the air enters the inside of the polarizing film, so that the water content by percentage in the polarizing film can be restrained from being changed. As a result, the polarizing film itself can be restrained from being curled or changed in dimension by a storage environment of the film.

The material which forms the transparent protective film laid over one surface or each of two surfaces of the polarizer is preferably a material excellent in transparency, mechanical strength, thermal stability, water blocking performance, isotropy and others, and is more preferably a material the humidity permeability of which is particularly 150 g/m²/24-hours or less, in particular preferably 140 g/m²/24-hours or less, more preferably 120 g/m²/24-hours or less. The humidity permeability is gained by a method described in the item EXAMPLES in the document.

Examples of the forming material for the transparent protective film satisfying the above-mentioned low humidity permeability include polyester polymers, such as polyethylene terephthalate and polyethylene naphthalate; polycarbonate resins; arylate-based resins; amide-based resins such as nylon and aromatic polyamide; polyolefin-based polymers such as polyethylene, polypropylene, ethylene/propylene copolymer, cyclic olefin-based resins having a cyclic or norbornene structure, and (meth)acryl-based resins; and mixtures each made of two or more of these resins. Out of these resins, preferred are polycarbonate-based resins, cyclic polyolefin-based resins and (meth)acryl-based resins, and particularly preferred are cyclic polyolefin-based resins and (meth)acryl-based resins.

The thickness of the transparent protective film may be appropriately decided, and is generally from about 1 to 100 in particular preferably from 1 to 80 μm, more preferably from 3 to 60 μm from the viewpoint of the strength, the handleability and other workabilities of the film, the layer-thinness of the film, and other factors.

When transparent protective films are laid, respectively, onto the front and rear surfaces of a polarizer, it is allowable to use, on the front and rear sides, transparent protective films made of the same polymeric material, or transparent protective films made of different materials of a polymeric species or some other species.

A functional layer may be laid onto the surface of the transparent protective film onto which no polarizer is adhered, this layer being, for example, a hard coat layer, an anti-reflection layer, a sticking-preventing layer, a diffusion layer or an anti-glare layer. The functional layer, which may be a hard coat layer, an anti-reflection layer, a sticking-preventing layer, a diffusion layer or an anti-glare layer, may be fitted to the transparent protective film itself, or may be separately disposed in the form of a member separated from the transparent protective film.

### <Optical Film>

When put into practical use, the polarizing film of the present invention is usable in the form of an optical film in which the polarizing film is laminated onto another optical layer. The optical layer is not particularly limited. Examples of the optical layer include a reflector, a semi-transmissible plate, retardation plates (for example, a wavelength plates such as quarter wavelength plate and a half wavelength plate), and viewing angle compensation film, and other layers usable to form a liquid crystal display device, or the like. These layers may be used singly or in the form of two or more layers thereof. The polarizing film of the present invention is in particular preferably a reflection type polarizing film in which a reflector or a semi-transmissible reflector is further laminated on the polarizing film of the invention, an elliptically or circularly polarizing film in which a retardation plate is further laminated on the polarizing film, a wide viewing angle polarizing film in which a viewing angle compensation film is further laminated on the polarizing film, or a polarizing film in which a brightness enhancement film is further laminated on the polarizing film.

An optical film in which the optical layers are laminated onto the polarizing film may be formed in such a manner that the layers are successively and individually laminated onto each other in a process for producing, for example, a liquid crystal cell display device. An optical film prepared by laminating the layers beforehand onto each other is excellent in quality stability, fabricating workability and others to have an advantage of improving a process for producing, for example, liquid crystal display devices. For the laminating, a pressure-sensitive adhesive layer or any other appropriate pressure-sensitive adhesive means may be used. In the adhering of the polarizing film or the other optical film(s), their optical axis may be adjusted to have an appropriate location angle in accordance with, for example, a target retardation property.

In the above-mentioned polarizing film, or an optical film in which the polarizing film or such polarizing films are laminated onto a member, a pressure-sensitive adhesive layer may be laid for bonding this polarizing film or optical film onto a different member such as a liquid crystal cell. A pressure-sensitive adhesive agent which forms the pressure-sensitive adhesive layer is not particularly limited. This agent may be appropriately selected from the following and used: pressure-sensitive adhesive agents each containing, as a base polymer thereof, an acryl-based polymer, silicone-based polymer, polyester, polyurethane, polyamide, polyether, fluorine-containing polymer, rubbery polymer, or some other polymer. The acryl-based pressure-sensitive adhesive agent is in particular preferably an agent which is excellent in optical transparency, and shows adherability of appropriate wettability, cohesive property and adhesion to be excellent in weather resistance, heat resistance and others.

Pressure-sensitive adhesive layers different from each other in composition or species may be laid, as superimposed layers, onto a single surface or each surface of the polarizing film or the optical film. When pressure-sensitive adhesive layers are laid, respectively, onto both surfaces of the film, these layers may be different from each other in, for example, composition, species or thickness on the front and rear side of the film. The thickness of (each of) the pressure-sensitive adhesive layer(s) may be appropriately decided in accordance with, for example, the use purpose and adhering strength thereof. The thickness is generally from 1 to 500 μm, preferably from 1 to 200 μm, in particular preferably from 1 to 100 μm.

A separator is temporarily adhered to a naked surface of the pressure-sensitive adhesive layer to cover the surface in order to attain the prevention of the pollution of the surface, and other purposes until the polarizing film is put into practical use. This coverage makes it possible to prevent an object or a person from contacting the pressure-sensitive adhesive layer in the state that the polarizing film is ordinarily handled. The separator may be an appropriate separator according to conventional techniques except the above-mentioned thickness conditions. The separator may be an appropriate flat piece yielded according to the prior art, such as a plastic film, a rubber sheet, a paper, cloth or nonwoven cloth piece, a net, a foamed sheet or a metal foil piece; a laminated body of such flat pieces; or a product in which such a flat piece is optionally subjected to coating treatment with an appropriate release agent, such as a silicone type, long-chain alkyl type or fluorine-containing type agent, or molybdenum sulfide.

### <Image Display Device>

The polarizing film or optical film of the present invention is preferably usable to form various devices such as a liquid crystal display device. The formation of the liquid crystal display device may be attained in accordance with the prior art. In other words, any liquid crystal display device is generally formed by fabricating appropriately a liquid crystal cell, a polarizing film or optical film, an optional lighting system, and other constituent parts, and then integrating a driving circuit into the resultant. In the present invention, a method for forming the liquid crystal display device of the invention is not particularly limited as far as the polarizing film or optical film according to the invention is used. The method is substantially according to the prior art. The liquid crystal cell may be also of any type, such as a TN type, STN type or it type.

An appropriate liquid crystal display device may be formed, examples thereof including a liquid crystal display device in which a polarizing film or optical film is arranged onto a single side or each of two sides of a liquid crystal cell, and a liquid crystal display device in which a backlight or reflector is used as a lighting system. In this case, any polarizing film or optical film according to the present invention can be set on the single side or each of the two sides of the liquid crystal cell. When polarizing films or optical films of the invention are set up, respectively, on the two sides, these may be the same as or different from each other. When the liquid crystal display device is formed, one or more appropriate components may be further arranged, at one or more appropriate positions of the device, in the form of one or two or more layers of the component(s), examples of these components including a diffusion plate, an anti-glare layer, an anti-reflection film, a protective plate, a prism array, a lens array sheet, a light diffusion plate, and a backlight.

### EXAMPLES

Hereinafter, working examples of the present invention will be described. However, embodiments of the invention are not limited thereto.

### <Production of Each Polarizer>

A film of a polyvinyl alcohol having an average polymerization degree of 2400 and a saponification degree of 99.9% by mol, the thickness of the film being 75 μm, was immersed in hot water of 30° C. temperature for 60 seconds to be swollen. Next, the film was immersed in an aqueous solution of iodine and potassium iodide (ratio by weight=0.5/8), the concentration thereof being 0.3%, and the film was dyed while drawn into a length 3.5 times the original length. Thereafter, the film was drawn in an aqueous solution of a boric acid ester of 65° C. temperature to give a total draw ratio of 6. After the drawing, the film was dried in an oven of 40° C. temperature for 3 minutes. In this way, each PVA-based polarizer (thickness: 23 μm) was yielded.

### <Each Transparent Protective Film>

A COP film having a thickness of 23 μm (ZF14, manufactured by Nippon Zeon Co., Ltd.) and subjected to corona treatment was used as each transparent protective film.

### <Bulk Water Absorption>

A curing type adhesive used in each working example, for polarizing film, was used, and sandwiched between two glass pieces to each of which a spacer of 100 μm size was fitted, and under active energy conditions as in the working example, the adhesive was cured to prepare an adhesive layer (cured product) having a thickness of 100 μm. This was used as a sample. The weight of the sample was represented by (M1) g. The sample M1 g was immersed in pure water of 23° C. temperature for 24 hours. Thereafter, the sample was taken out from the pure water, and the remaining water was wiped off with a dried cloth. Within one minute of the wiping, the weight (M2) g of the sample was again measured. From these results, the bulk water absorption of the sample was calculated out in accordance with the following expression:

{(M2−M1)/M1}×100(%)

### <Storage Modulus>

A dynamic viscoelasticity measuring instrument RSAIII manufactured by a company TA Instruments was used to measure the storage modulus of a sample under the following measuring condition:

Sample size: 10 mm in width and 30 mm in length,

Clamp distance: 20 mm,

Measuring mode: tension, frequency: 1 Hz, and temperature-raising rate: 5° C./minute. The dynamic viscoelasticity of the sample was used, and a measured value of the storage modulus at 25° C. was gained.

### <Active Energy Rays>

As active energy rays, the following was used: visible rays (gallium sealed metal halide lamp). Radiating device: Light HAMMER 10, manufactured by Fusion UV Systems, Inc.; bulb: V bulb; peak illuminance: 1600 mW/cm²; and cumulative radiation quantity: 1000/mJ/cm² (wavelengths: 380 to 440 nm). The illuminance of the visible rays was measured, using a Sola-Check system manufactured by Solatell Ltd.

### Examples 1 to 27, and Comparative Examples 1 to 19

### (Preparation of Curing Type Adhesive Compositions for Polarizing Film)

In each of the examples, in accordance with a blend list described in one of Tables 1 to 4, a composition was prepared which contained active energy ray curable components (X), a radical polymerizable compound (B) and others except any organometallic compound (A). These components were sufficiently mixed with each other, and thereto was added an organometallic compound (A) described in the table of Tables 1 to 4. The components were further sufficiently mixed with each other, and then allowed to stand still for 30 minutes. After the still-standing for the 30 minutes, out of the resultant respective adhesive compositions of the examples, any composition transparent and excellent in liquid stability was estimated to be good (circular mark), any semi-transparent composition, to be fair (triangular mark) and any composition which was made clouded or underwent the generation of a precipitation, to be bad (cross mark) (this stability estimation was referred to also as “initial estimation after blending”). Furthermore, after the compositions were each allowed to stand still for 24 hours, the stability of the adhesive composition liquid was estimated in accordance with the above-mentioned criterion (this stability estimation was referred to also as “estimation at 24 hours after blending”). The results are shown in Tables 1 to 9.

In the same way, in each of the examples, in accordance with a blend list described in one of Tables 1 to 4, a composition was prepared which contained active energy ray curable components (X), a radical polymerizable compound (B) and others except any organometallic compound (A). These components were sufficiently mixed with each other, and then thereto was added an organometallic compound (A) described in the table of Tables 1 to 4. The components were sufficiently mixed with each other, and then allowed to stand still for 30 minutes. Into this composition was incorporated water in a proportion of 1% by weight, and these components were sufficiently mixed with each other. Thereafter, the mixture was allowed to stand still for 30 minutes. The liquid stability of the resultant adhesive composition was then estimated in accordance with the above-mentioned criterion (this stability estimation is referred to also as “initial estimation after water incorporation”). Furthermore, the adhesive composition was allowed to stand still for 24 hours, and the stability of the adhesive composition liquid was estimated in accordance with the above-mentioned criterion (this stability estimation is referred to also as “estimation at 24 hours after water incorporation”). The results are shown in Tables 1 to 4.

In Tables 1 to 4, the active energy ray curable components (X) are:

HEAA; hydroxyethylacrylamide, manufactured by Kojin Co., Ltd.;

ACMO: acryloylmorpholine, manufactured by Kojin Co., Ltd.; and

M-220: polypropylene glycol (n≈3) diacrylate, manufactured by Toagosei Co., Ltd.

Radical polymerizable compounds (B) were:

HOA-MS: 2-acryloyloxyethyl-succinic acid, manufactured by Kyoeisha Chemical Co., Ltd., molecular weight 216.19 g/mol;

HOA-HH: 2-acryloyloxyethylhexahydrophthalic acid, manufactured by Kyoeisha Chemical Co., Ltd., molecular weight: 270.27 g/mol;

M-5400: 2-acryloyloxyethylphthalic acid, manufactured by Toagosei Co., Ltd., molecular weight 264.25 g/mol; and

M-5300: ω-carboxy-polycaprolactone (n≈2) monoacrylate, manufactured by Toagosei Co., Ltd., the molecular weight: 300.16 g/mol.

Organometallic compounds (A) were:

TA-10: titanium isopropoxide (carbon atom number of the organic group: 3), manufactured by Matsumoto Fine Chemical Co., Ltd.;

TA-21: titanium butoxide (carbon atom number of the organic group: 4), manufactured by Matsumoto Fine Chemical Co., Ltd.;

TA-30: titanium octoxide (carbon atom number of the organic group: 8), manufactured by Matsumoto Fine Chemical Co., Ltd.; and

TC-100: titanium acetylacetonate (carbon atom number of the organic group: 5), manufactured by Matsumoto Fine Chemical Co., Ltd.

Other components in the adhesive compositions were:

UP-1190, manufactured by Toagosei Co., Ltd.

Irg. 907: IRGACURE 907 (2-methyl-1-(4-methylthiophenyl)-2-morpholinopropane-1-one, manufactured by the BASF); and

DETX-S: KAYACURE-DETX-S(2,4-diethylthioxanthone, manufactured by Nippon Kayaku Co., Ltd.).

Compounds which have no carboxyl group and which a metal can be coordinated to were:

AAEM: 2-acetoacetoxyethyl methacrylate, manufactured by the Nippon Synthetic Chemical Industry Co., Ltd., molecular weight: 214.22 g/mol; and

β-Diketone: acetylacetone, manufactured by Daicel Chemical Industries, Ltd., molecular weight: 100.117 g/mol.

Any one of the adhesive compositions that was estimated to be good or fair in the “estimation at 24 hours after blending” was used, and this composition was painted onto any one of the above-mentioned transparent protective films into a thickness of 0.7 μm, using an MCD coater (manufactured by Fuji Machin Mfg. Co., Ltd.) (cell shape: honeycomb, the number of gravure roll lines: 1000/inch, rotation speed: 140% of the line speed). Two pieces of the resultant composition-painted film were caused to bond, respectively, onto both surfaces of any one of the above-mentioned polarizers, using a roll machine. Thereafter, an active energy ray radiating device was used to radiate the above-mentioned visible rays onto both surfaces of the resultant bonded body from the adherent transparent protective film sides (both sides) thereof to cure the active energy ray curing type adhesive. The resultant was then dried with hot wind at 70° C. for 3 minutes to yield each polarizing film having the transparent protective films, respectively, on both sides of the polarizer in each of the examples.

<Adhering Strength Estimation (at 24 Hours after Blending)>

In each of the examples, one of the polarizing films yielded as described above was cut out into a size of 200 mm in a direction parallel to the drawn direction of the polarizer and 15 mm in a direction orthogonal thereto. The cut film was caused to bond to a glass plate. A utility knife was used to make a cut into between one of the (acrylic or TAC) transparent protective films and the polarizer. A machine TENSILON was used to peel off the protective film and the polarizer from each other into a 90-degree direction at a peel rate of 1000 mm/min., and the peel strength (N/15-mm) therebetween was measured; or when the peel strength was 1 N/15-mm or more, the polarizing film was estimated to be good (circular mark). When the strength was less than 1 N/15-mm, the film was estimated to be bad (cross mark). The results are shown in Tables 1 to 4.

The following was used: any one of the adhesive compositions (each containing water in a proportion of 1% by weight of the composition) that was estimated to be good or fair in the “estimation at 24 hours after water incorporation”. This composition was painted onto any one of the above-mentioned transparent protective films into a thickness of 0.7 using an MCD coater (manufactured by Fuji Machin Mfg. Co., Ltd.) (cell shape: honeycomb, the number of gravure roll lines: 1000/inch, rotation speed: 140% of the line speed). Two pieces of the resultant component-painted film were caused to bond, respectively, onto both surfaces of any one of the above-mentioned polarizers, using a roll machine. Thereafter, an active energy ray radiating device was used to radiate the above-mentioned visible rays onto both surfaces of the resultant bonded body from the adherent transparent protective film sides (both sides) thereof to cure the active energy ray curing type adhesive. The resultant was then dried with hot wind at 70° C. for 3 minutes to yield a polarizing film having the transparent protective films, respectively, on both sides of the polarizer.

<Adhering Strength Estimation (at 24 Hours after Water Incorporation)>

Another of the polarizing films yielded as described above was cut out into a size of 200 mm in a direction parallel to the drawn direction of the polarizer and 15 mm in a direction orthogonal thereto. The cut film was caused to bond to a glass plate. A utility knife was used to make a cut into between one of the (acrylic or TAC) transparent protective films and the polarizer. A machine TENSILON was used to peel off the protective film and the polarizer from each other into a 90-degree direction at a peel rate of 1000 mm/min., and the peel strength (N/15-mm) therebetween was measured. when the peel strength was 1 N/15-mm or more, the polarizing film was estimated to be good (circular mark); when the strength was less than 1 N/15-mm, and 0.5 N/15-mm or more, the film was estimated to be fair (triangular mark); or when the peel strength was less than 0.5 N/15-mm, the polarizing film was estimated to be bad (cross mark).

### <Humidity Endurance Test>

Any one of the adhesive compositions that was estimated to be good or fair in the “estimation at 24 hours after water incorporation” was used. Still another of the resultant polarizing films, in each of which this composition was used, was cut out into a size of 200 mm in a direction parallel to the drawn direction of the polarizer and 15 mm in a direction orthogonal thereto. The cut polarizing film was put in a humidity environment testing machine (at 20° C. and 98% RH) for 240 hours, and then taken out. Within 10 minutes of the film-taking-out, the polarizing film (in an undried state) was caused to bond to a glass plate. A utility knife was used to make a cut into between one of the transparent protective films and the polarizer. A machine TENSILON was used to peel off the protective film and the polarizer from each other into a 90-degree direction at a peel rate of 300 mm/min., and the peel strength (N/15-mm) therebetween was measured. When the peel strength was 1 N/15-mm or more, the polarizing film was estimated to be very good (double circular mark). When the strength was less than 1 N/15-mm, and 0.8 N/15-mm or more, the film was estimated to be good (circular mark). When the strength was less than 0.8 N/15-mm and less than 0.5 N/15-mm, the film was estimated to be bad (cross mark). The results are shown in Tables 1 to 9.

TABLE 1

| | | | Examples | | | | | | | | | | | | |
|---|---|---|---|---|---|---|---|---|---|---|---|---|---|---|---|
| | | | 1 | 2 | 3 | 4 | 5 | 6 | 7 | 8 | 9 | 10 | 11 | 12 | 13 |
| Adhesive | Active energy | HEAA | 11.2 | 10.7 | 11.2 | 10.9 | 11.4 | 11.1 | 11.5 | 11.4 | 11.1 | 10.7 | 11.5 | 11.4 | 11.1 |
| composition | ray curable | ACMO | 11.2 | 10.7 | 11.2 | 10.9 | 11.4 | 11.1 | 11.5 | 11.4 | 11.1 | 10.7 | 11.5 | 11.4 | 11.1 |
| | components | M-220 | 55.8 | 53.6 | 56.1 | 54.3 | 56.9 | 55.7 | 57.5 | 56.9 | 55.7 | 53.4 | 57.5 | 56.9 | 55.7 |
| | (X) | | | | | | | | | | | | | | |
| | Oligomer | UP-1190 | 11.2 | 10.7 | 11.2 | 10.9 | 11.4 | 11.1 | 11.5 | 11.4 | 11.1 | 10.7 | 11.5 | 11.4 | 11.1 |
| | component | | | | | | | | | | | | | | |
| | Initiators | Irg. 907 | 2.7 | 2.6 | 2.7 | 2.6 | 2.7 | 2.7 | 2.8 | 2.7 | 2.7 | 2.6 | 2.8 | 2.7 | 2.7 |
| | | DETX-S | 1.3 | 1.3 | 1.3 | 1.3 | 1.4 | 1.3 | 1.4 | 1.4 | 1.3 | 1.3 | 1.4 | 1.4 | 1.3 |
| | Organo- | TA-10 | 2.7 | 2.6 | | | | | | | | | | | |
| | metaLlic | TA-21 | | | 2.7 | 2.6 | | | 2.8 | 2.7 | 2.7 | 2.6 | 2.8 | 2.7 | 2.7 |
| | compounds (A) | TA-30 | | | | | 2.7 | 2.7 | | | | | | | |
| | | TC-100 | | | | | | | | | | | | | |
| | Polymerizable | HOA-MS | 4.1 | 7.9 | 3.4 | 6.7 | 2.2 | 4.2 | | | | | | | |
| | compounds (B) | HOA-HH | | | | | | | 1.1 | 2.2 | 4.2 | 8.1 | | | |
| | | M-5400 | | | | | | | | | | | 1.1 | 2.1 | 4.2 |
| | | M-5300 | | | | | | | | | | | | | |
| | Metal- | AAEM | | | | | | | | | | | | | |
| | coordinatable | Acetylacetone | | | | | | | | | | | | | |
| | compounds | | | | | | | | | | | | | | |
| | having no | | | | | | | | | | | | | | |
| | carboxyl group | | | | | | | | | | | | | | |
| | Ratio by mole of (B) to (A)¹⁾ | | 2.0 | 4.0 | 2.0 | 4.0 | 2.0 | 4.0 | 0.5 | 1.0 | 2.0 | 4.0 | 0.5 | 1.0 | 2.0 |
| Liquid stability of | | Initial estimation | ◯ | ◯ | ◯ | ◯ | ◯ | ◯ | ◯ | ◯ | ◯ | ◯ | ◯ | ◯ | ◯ |
| adhesive composition | | after blending | | | | | | | | | | | | | |
| | | Estimation at 24 hours | ◯ | ◯ | ◯ | ◯ | ◯ | ◯ | ◯ | ◯ | ◯ | ◯ | ◯ | ◯ | ◯ |
| | | after blending | | | | | | | | | | | | | |
| | | Initial estimation | ◯ | ◯ | ◯ | ◯ | ◯ | ◯ | ◯ | ◯ | ◯ | ◯ | ◯ | ◯ | ◯ |
| | | after water incorporation | | | | | | | | | | | | | |
| | | Estimation at 24 hours | ◯ | ◯ | ◯ | ◯ | ◯ | ◯ | Δ | ◯ | ◯ | ◯ | Δ | ◯ | ◯ |
| | | after water incorporation | | | | | | | | | | | | | |
| Adhesive | Bulk water absorption (%) | | 9.3 | 9.4 | 9.3 | 9.5 | 9.3 | 9.3 | 9.2 | 9.2 | 9.1 | 9.0 | 9.2 | 9.2 | 9.1 |
| layer | Storage modulus (×10⁹ (Pa)) (at 25° C.) | | 1.5 | 1.3 | 1.5 | 1.4 | 1.8 | 1.5 | 1.9 | 1.8 | 1.7 | 1.5 | 1.9 | 1.9 | 1.8 |
| properties | Adhesive | Peel strength (N/15-mm) | 1.4 | 1.5 | 1.1 | 1.0 | 1.2 | 1.0 | 2.1 | 1.8 | 1.5 | 1.0 | 1.9 | 1.3 | 1.4 |
| | performance | at 24 hours after blending | | | | | | | | | | | | | |
| | evaluations | Estimation | ◯ | ◯ | ◯ | ◯ | ◯ | ◯ | ◯ | ◯ | ◯ | ◯ | ◯ | ◯ | ◯ |
| | | Peel strength (N/15-mm) | 1 | 1 | 0.8 | 0.8 | 0.9 | 0.8 | 1.3 | 1.6 | 1.4 | 0.7 | 1.2 | 1.2 | 1.3 |
| | | at 24 hours after water | | | | | | | | | | | | | |
| | | incorporation | | | | | | | | | | | | | |
| | | Estimation | ◯ | ◯ | Δ | Δ | Δ | Δ | ◯ | ◯ | ◯ | Δ | ◯ | ◯ | ◯ |
| | | Humidity endurance peel | 0.9 | 0.7 | 0.8 | 0.7 | 0.8 | 0.6 | 0.7 | 1.1 | 1.0 | 0.7 | 0.7 | 1.1 | 1.0 |
| | | strength (N/15-mm) | | | | | | | | | | | | | |
| | | Estimation | ◯ | Δ | ◯ | Δ | ◯ | Δ | Δ | ⊙ | ⊙ | Δ | Δ | ⊙ | ⊙ |

¹⁾In any example in which a metal-coordinatable compound having carboxyl group, the ratio shows the ratio by mole of the metal-coordinatable compound having carboxyl group to the compound (A).

TABLE 2

| | | | Examples | | | | | | |
|---|---|---|---|---|---|---|---|---|---|
| | | | 14 | 15 | 16 | 17 | 18 | 19 | 20 |
| Adhesive | Active energy ray | HEAA | 10.7 | 11.5 | 11.3 | 11.0 | 10.4 | 11.5 | 11.3 |
| composition | curable components (X) | ACMO | 10.7 | 11.5 | 11.3 | 11.0 | 10.4 | 11.5 | 11.3 |
| | | M-220 | 53.5 | 57.3 | 56.5 | 54.9 | 52.0 | 57.4 | 56.7 |
| | Oligomer component | UP-1190 | 10.7 | 11.5 | 11.3 | 11.0 | 10.4 | 11.5 | 11.3 |
| | Initiators | Irg.907 | 2.6 | 2.8 | 2.7 | 2.6 | 2.5 | 2.8 | 2.7 |
| | | DETX-S | 1.3 | 1.4 | 1.4 | 1.3 | 1.2 | 1.4 | 1.4 |
| | Organometallic | TA-10 | | 2.8 | 2.7 | 2.6 | 2.5 | | |
| | compounds (A) | TA-21 | 2.6 | | | | | 2.8 | 2.7 |
| | | TA-30 | | | | | | | |
| | | TC-100 | | | | | | | |
| | Polymerizable | HOA-MS | | | | | | | |
| | compounds (B) | HOA-HH | | | | | | | |
| | | M-5400 | 8.0 | | | | | | |
| | | M-5300 | | 1.5 | 2.9 | 5.6 | 10.5 | 1.2 | 2.4 |
| | Metal-coordinatable | AAEM | | | | | | | |
| | compounds having no | Acetylacetone | | | | | | | |
| | carboxyl group | | | | | | | | |
| | Ratio by mole of (B) to (A)¹⁾ | | 4.0 | 0.5 | 1.0 | 2.0 | 4.0 | 0.5 | 1.0 |
| Liquid stability of adhesive | | Initial estimation | ◯ | ◯ | ◯ | ◯ | ◯ | ◯ | ◯ |
| composition | | after blending | | | | | | | |
| | | Estimation at 24 hours | ◯ | ◯ | ◯ | ◯ | ◯ | ◯ | ◯ |
| | | after blending | | | | | | | |
| | | Initial estimation | ◯ | ◯ | ◯ | ◯ | ◯ | ◯ | ◯ |
| | | after water incorporation | | | | | | | |
| | | Estimation at 24 hours | ◯ | ◯ | ◯ | ◯ | ◯ | ◯ | ◯ |
| | | after water incorporation | | | | | | | |
| Adhesive | Bulk water absorption (%) | | 9.0 | 9.2 | 9.2 | 9.1 | 9.0 | 9.2 | 9.2 |
| layer | Storage moculus (×10⁹ (Pa)) (at 25° C.) | | 1.6 | 1.9 | 1.9 | 1.7 | 1.4 | 1.9 | 1.8 |
| properties | Adhesive performance | Peel strength (N/15-mm) | 1.0 | 1.7 | 1.7 | 1.6 | 1.5 | 1.7 | 1.2 |
| | evaluations | at 24 hours after blending | | | | | | | |
| | | Estimation | ◯ | ◯ | ◯ | ◯ | ◯ | ◯ | ◯ |
| | | Peel strength (N/15-mm) | 0.7 | 0.9 | 1.3 | 1.2 | 1.1 | 0.9 | 1.2 |
| | | at 24 hours after water | | | | | | | |
| | | incorporation | | | | | | | |
| | | Estimation | Δ | Δ | ◯ | ◯ | ◯ | Δ | ◯ |
| | | Humidity endurance peel | 0.7 | 0.7 | 1.0 | 1.0 | 0.7 | 0.8 | 1.1 |
| | | strength (N/15-mm) | | | | | | | |
| | | Estimation | Δ | Δ | ◯ | ◯ | Δ | ◯ | ⊙ |
| | | | Examples | | | | | | |
| | | | 21 | 22 | 23 | 24 | 25 | 26 | 27 |
| Adhesive | Active energy ray | HEAA | 11.1 | 10.6 | 11.8 | 10.5 | 11.3 | 11.0 | 8.9 |
| composition | curable components (X) | ACMO | 11.1 | 10.6 | 11.8 | 10.5 | 11.3 | 11.0 | 8.9 |
| | | M-220 | 55.4 | 52.9 | 58.8 | 52.3 | 56.4 | 54.8 | 44.5 |
| | Oligomer component | UP-1190 | 11.1 | 10.6 | 11.8 | 10.5 | 11.3 | 11.0 | 8.9 |
| | Initiators | Irg.907 | 2.7 | 2.5 | 2.8 | 2.5 | 2.7 | 2.6 | 2.1 |
| | | DETX-S | 1.3 | 1.3 | 1.4 | 1.3 | 1.4 | 1.3 | 1.1 |
| | Organometallic | TA-10 | | | | | | | |
| | compounds (A) | TA-21 | 2.7 | 2.5 | 0.9 | 6.7 | | | |
| | | TA-30 | | | | | 2.7 | 2.6 | 2.1 |
| | | TC-100 | | | | | | | |
| | Polymerizable | HOA-MS | | | | | | | |
| | compounds (B) | HOA-HH | | | | | | | |
| | | M-5400 | | | | | | | |
| | | M-5300 | 4.7 | 9.0 | 0.8 | 5.9 | 3. 0 | 5.7 | 23.5 |
| | Metal-coordinatable | AAEM | | | | | | | |
| | compounds having no | Acetylacetone | | | | | | | |
| | carboxyl group | | | | | | | | |
| | Ratio by mole of (B) to (A)¹⁾ | | 2.0 | 4.0 | 1.0 | 1.0 | 2.0 | 4.0 | 10.0 |
| Liquid stability of adhesive | | Initial estimation | ◯ | ◯ | ◯ | ◯ | ◯ | ◯ | ◯ |
| composition | | after blending | | | | | | | |
| | | Estimation at 24 hours | ◯ | ◯ | ◯ | ◯ | ◯ | ◯ | ◯ |
| | | after blending | | | | | | | |
| | | Initial estimation | ◯ | ◯ | ◯ | ◯ | ◯ | ◯ | ◯ |
| | | after water incorporation | | | | | | | |
| | | Estimation at 24 hours | ◯ | ◯ | ◯ | ◯ | ◯ | ◯ | ◯ |
| | | after water incorporation | | | | | | | |
| Adhesive | Bulk water absorption (%) | | 9.1 | 9.0 | 9.2 | 9.1 | 9.2 | 9.1 | 9.0 |
| layer | Storage moculus (×10⁹ (Pa)) (at 25° C.) | | 1.7 | 1.5 | 1.9 | 1.7 | 1.8 | 1.7 | 1.0 |
| properties | Adhesive performance | Peel strength (N/15-mm) | 1.2 | 1.2 | 1.4 | 2.0 | 1.4 | 1.5 | 1.1 |
| | evaluations | at 24 hours after blending | | | | | | | |
| | | Estimation | ◯ | ◯ | ◯ | ◯ | ◯ | ◯ | ◯ |
| | | Peel strength (N/15-mm) | 1.1 | 1 | 1 | 1.8 | 1.2 | 1.2 | 1 |
| | | at 24 hours after water | | | | | | | |
| | | incorporation | | | | | | | |
| | | Estimation | ◯ | ◯ | ◯ | ◯ | ◯ | ◯ | ◯ |
| | | Humidity endurance peel | 1.0 | 0.8 | 1.0 | 1.4 | 1.0 | 0.8 | 0.7 |
| | | strength (N/15-mm) | | | | | | | |
| | | Estimation | ⊙ | ◯ | ⊙ | ⊙ | ⊙ | ◯ | Δ |

¹⁾In any example in which a metal-coordinatable compound having carboxyl group, the ratio shows the ratio by mole of the metal-coordinatable compound having carboxyl group to the compound (A).

TABLE 3

| | | | Comparative Examples | | | | | | |
|---|---|---|---|---|---|---|---|---|---|
| | | | 1 | 2 | 3 | 4 | 5 | 6 | 7 |
| Adhesive | Active energy | HEAA | 11.6 | 11.6 | 11.6 | 11.6 | 11.2 | 10.7 | 11.5 |
| composition | ray curable | ACMO | 11.6 | 11.6 | 11.6 | 11.6 | 11.2 | 10.7 | 11.5 |
| | components (X) | M-220 | 58.1 | 58.1 | 58 | 58.1 | 55.8 | 53.6 | 57.6 |
| | Oligomer component | UP-1190 | 11.6 | 11.6 | 11.6 | 11.6 | 11.2 | 10.7 | 11.5 |
| | Initiators | Irg.907 | 2.8 | 2.8 | 2.8 | 2.8 | 2.7 | 2.6 | 2.8 |
| | | DETX-S | 1.4 | 1.4 | 1.4 | 1.4 | 1.3 | 1.3 | 1.4 |
| | Organometallic | TA-10 | 2.8 | | | | 2.7 | 2.6 | |
| | compounds (A) | TA-21 | | 2.8 | | | | | 2.8 |
| | | TA-30 | | | 2.8 | | | | |
| | | TC-100 | | | | 2.8 | | | |
| | Polymerizable | HOA-MS | | | | | | | |
| | compounds (B) | HOA-HH | | | | | | | |
| | | M-5400 | | | | | | | |
| | | M-5300 | | | | | | | |
| | Metal-coordinatable | AAEM | | | | | 4.0 | 7.8 | 0.9 |
| | compounds having no | Acetylacetone | | | | | | | |
| | carboxyl group | | | | | | | | |
| | Ratio by mole of (B) to (A)¹⁾ | | | | | | 2.0 | 4.0 | 0.5 |
| Liquid stability of adhesive | | Initial estimation | ◯ | ◯ | X | ◯ | ◯ | ◯ | X |
| composition | | after blending | | | | | | | |
| | | Estimation at 24 hours | ◯ | ◯ | X | ◯ | ◯ | ◯ | X |
| | | after blending | | | | | | | |
| | | Initial estimation | X | X | X | ◯ | X | ◯ | X |
| | | after water incorporation | | | | | | | |
| | | Estimation at 24 hours | X | X | X | ◯ | X | X | X |
| | | after water incorporation | | | | | | | |
| Adhesive | Bulk water absorption (%) | | 9.2 | 9.2 | 9.2 | 9.2 | 9.5 | 9.8 | 9.2 |
| layer | Storage modulus (×10⁹ (Pa)) (at 25° C.) | | 1.9 × 10\hat{ }9 | 1.9 × 10\hat{ }9 | 1.9 | 1.9 | 1.7 | 1.5 | 1.9 |
| properties | Adhesive | Peel strength (N/15-mm) | 2.0 | 2.4 | — | 0.8 | 1.5 | 1.9 | — |
| | performance | at 24 hours after blending | | | | | | | |
| | evaluations | Estimation | ◯ | ◯ | — | X | ◯ | ◯ | — |
| | | Peel strength (N/15-mm) | — | — | — | 0.4 | — | — | — |
| | | at 24 hours after water | | | | | | | |
| | | incorporation | | | | | | | |
| | | Estimation | — | — | — | X | — | — | — |
| | | Humidity endurance peel | — | — | — | 0.4 | — | — | — |
| | | strength (N/15-mm) | | | | | | | |
| | | Estimation | — | — | — | X | — | — | — |

¹⁾In any example in which a metal-coordinatable compound having carboxyl group, the ratio shows the ratio by mole of the metal-coordinatable compound having carboxyl group to the compound (A).

TABLE 4

| | | | Comparative Examples | | | | | | | | | | | |
|---|---|---|---|---|---|---|---|---|---|---|---|---|---|---|
| | | | 8 | 9 | 10 | 11 | 12 | 13 | 14 | 15 | 16 | 17 | 18 | 19 |
| Adhesive | Active energy | HEAA | 11.4 | 11.2 | 10.9 | 11.4 | 11.1 | 11.4 | 11.2 | 11.6 | 11.5 | 11.4 | 11.3 | 12.0 |
| composition | ray curable | ACMO | 11.4 | 11.2 | 10.9 | 11.4 | 11.1 | 11.4 | 11.2 | 11.6 | 11.5 | 11.4 | 11.3 | 12.0 |
| | components (X) | M-220 | 57.1 | 56.2 | 54.3 | 56.9 | 55.7 | 57.0 | 55.9 | 57.9 | 57.7 | 57.2 | 56.3 | 59.8 |
| | Oligomer | UP-1190 | 11.4 | 11.2 | 10.9 | 11.4 | 11.1 | 11.4 | 11.2 | 11.6 | 11.5 | 11.4 | 11.3 | 12.0 |
| | component | | | | | | | | | | | | | |
| | Initiators | Irg.907 | 2.7 | 2.7 | 2.6 | 2.7 | 2.7 | 2.7 | 2.7 | 2.8 | 2.8 | 2.7 | 2.7 | 2.9 |
| | | DETX-S | 1.4 | 1.3 | 1.3 | 1.4 | 1.3 | 1.4 | 1.3 | 1.4 | 1.4 | 1.4 | 1.4 | 1.4 |
| | Organo- | TA-10 | | | | | | 2.7 | 2.7 | | | | | |
| | metallic | TA-21 | 2.7 | 2.7 | 2.6 | | | | | 2.8 | 2.8 | 2.7 | 2.7 | |
| | compounds (A) | TA-30 | | | | 2.7 | 2.7 | | | | | | | |
| | | TC-100 | | | | | | | | | | | | |
| | Polymerizable | HOA-MS | | | | | | | | | | | | |
| | compounds (B) | HOA-HH | | | | | | | | | | | | |
| | | M-5400 | | | | | | | | | | | | |
| | | M-5300 | | | | | | | | | | | | |
| | Metal- | AAEM | 1.7 | 3.4 | 6.6 | 2.1 | 4.2 | | | | | | | |
| | coordinatable | Acetylacetone | | | | | | 1.9 | 3.8 | 0.4 | 0.8 | 1.6 | 3.2 | |
| | compounds | | | | | | | | | | | | | |
| | having no | | | | | | | | | | | | | |
| | carboxyl | | | | | | | | | | | | | |
| | group | | | | | | | | | | | | | |
| | Ratio by mole of (B) to (A)¹⁾ | | 1.0 | 2.0 | 4.0 | 2.0 | 4.0 | 2.0 | 4.0 | 0.5 | 1.0 | 2.0 | 4.0 | |
| Liquid stability of adhesive | | Initial estimation | ◯ | ◯ | ◯ | ◯ | ◯ | ◯ | ◯ | ◯ | ◯ | ◯ | ◯ | ◯ |
| composition | | after blending | | | | | | | | | | | | |
| | | Estimation at 24 hours | X | ◯ | ◯ | ◯ | ◯ | ◯ | ◯ | ◯ | ◯ | ◯ | ◯ | ◯ |
| | | after blending | | | | | | | | | | | | |
| | | Initial estimation after water | X | ◯ | ◯ | X | ◯ | ◯ | ◯ | X | ◯ | ◯ | ◯ | ◯ |
| | | incorporation | | | | | | | | | | | | |
| | | Estimation at 24 hours | X | X | X | X | X | ◯ | ◯ | X | X | ◯ | ◯ | ◯ |
| | | after water incorporation | | | | | | | | | | | | |
| Adhesive | Bulk water absorption (%) | | 9.3 | 9.4 | 9.8 | 9.4 | 9.5 | 9.3 | 9.5 | 9.2 | 9.2 | 9.3 | 9.4 | 9.2 |
| layer | Storage modulus (×10⁹ (Pa)) (at 25° C.) | | 1.9 | 1.7 | 1.6 | 1.9 | 1.7 | 1.9 | 1.9 | 1.9 | 1.9 | 1.9 | 1.9 | 1.9 |
| properties | Adhesive | Peel strength (N/15-mm) | — | 1.6 | 1.4 | 1.7 | 1.8 | 0.7 | 0.3 | 1.2 | 1.1 | 0.7 | 0.6 | 0.3 |
| | performance | at 24 hours after blending | | | | | | | | | | | | |
| | evaluations | Estimation | — | ◯ | ◯ | ◯ | ◯ | X | X | ◯ | ◯ | X | X | X |
| | | Peel strength (N/15-mm) | — | — | — | — | — | 0.4 | 0.2 | — | — | 0.4 | 0.4 | 0.3 |
| | | at 24 hours after water | | | | | | | | | | | | |
| | | incorporation | | | | | | | | | | | | |
| | | Estimation | — | — | — | — | — | X | X | — | — | X | X | X |
| | | Humidity endurance peel | — | — | — | — | — | 0.4 | 0.2 | — | — | 0.3 | 0.2 | 0.2 |
| | | strength (N/15-mm) | | | | | | | | | | | | |
| | | Estimation | — | — | — | — | — | X | X | — | — | X | X | X |

¹⁾In any example in which a metal-coordinatable compound having carboxyl group, the ratio shows the ratio by mole of the metal-coordinatable compound having carboxyl group to the compound (A).

1. A curing type adhesive composition for polarizing film, comprising an active energy ray curable component (X), at least one organometallic compound (A) selected from the group consisting of a metal alkoxide and a metal chelate, and a polymerizable compound (B) having a polymerizable functional group and a carboxyl group.

2. The curing type adhesive composition for polarizing film according to claim 1, wherein a metal of the organometallic compound (A) is titanium.

3. The curing type adhesive composition for polarizing film according to claim 1, comprising, as the organometallic compound (A), the metal alkoxide, and an organic group which the metal alkoxide has having three or more carbon atoms.

4. The curing type adhesive composition for polarizing film according to claim 1, comprising, as the organometallic compound (A), the metal chelate, an organic group which the metal chelate has having four or more carbon atoms.

5. The curing type adhesive composition for polarizing film according to claim 1, wherein the proportion of the organometallic compound (A) is from 0.05 to 15% by weight for 100% by weight of the whole of the curing type adhesive composition for polarizing film.

6. The curing type adhesive composition for polarizing film according to claim 1, wherein the polymerizable compound (B) is a radical polymerizable compound.

7. The curing type adhesive composition for polarizing film according to claim 1, wherein the polymerizable compound (B) has a molecular weight of 100 (g/mol) or more.

8. The curing type adhesive composition for polarizing film according to claim 1, wherein the polymerizable compound (B) is a polymerizable compound having a polymerizable functional group and a carboxyl group to interpose, between the groups, an organic group which has 1 to 20 carbon atoms and may contain oxygen.

9. The curing type adhesive composition for polarizing film according to claim 1, about which when the total amount of the organometallic compound (A) in the curing type adhesive composition for polarizing film is represented by a (mol), the content of the polymerizable compound (B) in the composition is 0.25α (mol) or more.

10. The curing type adhesive composition for polarizing film according to claim 1, wherein in the case of immersing a cured product yielded by curing the curing type adhesive composition for polarizing film in pure water of 23° C. temperature for 24 hours, the cured product shows a bulk water absorption of 10% or less by weight, the bulk water absorption being represented by the following expression:
{(M2−M1)/M1}×100(%)
wherein M1: the weight of the cured product before the immersion, and M2: the weight of the cured product after the immersion.

11. The curing type adhesive composition for polarizing film according to claim 1, wherein the active energy ray curable component (X) comprises a radical polymerizable compound.

12. The curing type adhesive composition for polarizing film according to claim 11, wherein the radical polymerizable compound comprises a (meth)acrylamide derivative.

13. The curing type adhesive composition for polarizing film according to claim 11, wherein the radical polymerizable compound comprises a polyfunctional compound having at least two functional groups having radical polymerizability.

14. The curing type adhesive composition for polarizing film according to claim 1, further comprising a photopolymerization initiator.

15. The curing type adhesive composition for polarizing film according to claim 1, further comprising a compound having a vinyl ether group.

16. The curing type adhesive composition for polarizing film according to claim 1, further comprising an optical acid-generator.

17. The curing type adhesive composition for polarizing film according to claim 1, wherein a/the cured product yielded by curing the curing type adhesive composition for polarizing film has a storage modulus of 1.0×10⁷ Pa or more at 25° C.

18. A method for manufacturing the curing type adhesive composition recited in claim 1 for polarizing film,
the method comprising a first mixing step of mixing the active energy ray curable component (X) with the polymerizable compound (B), which has the polymerizable functional group and the carboxyl group, to yield a mixed curable component, and a second mixing step of mixing the mixed curable component with the at least one organometallic compound (A), which is selected from the group consisting of the metal alkoxide and the metal chelate.

19. A method for manufacturing the curing type adhesive composition recited in claim 1 for polarizing film,
the method comprising a first mixing step of mixing the at least one organometallic compound (A), which is selected from the group consisting of the metal alkoxide and the metal chelate, with the polymerizable compound (B), which has the polymerizable functional group and the carboxyl group, to yield an organometallic-compound-comprising composition, and a second mixing step of mixing the organometallic-compound-comprising composition with the active energy ray curable component.

20. A polarizing film, comprising a polarizer, and a transparent protective film laid over at least one surface of the polarizer to interpose an adhesive layer between the film and the surface,
wherein the adhesive layer is formed to comprise a layer of a cured product of the curing type adhesive composition recited in claim 1 for polarizing film.

21. The polarizing film according to claim 20, wherein the adhesive layer has a thickness of 0.1 to 3 μm.

22. The polarizing film according to claim 20, wherein in the case of immersing the adhesive layer in pure water of 23° C. temperature for 24 hours, the adhesive layer shows a bulk water absorption of 10% or less by weight, the bulk water absorption being represented by the following expression:
{(M2−M1)/M1}×100(%)
wherein M1: the weight of the cured product before the immersion, and M2: the weight of the cured product after the immersion.

23. The polarizing film according to claim 20, wherein the adhesive layer has a storage modulus of 1.0×10⁷ Pa or more at 25° C.

24. A method for manufacturing the polarizing film recited in claim 20,
the method comprising:
an applying step of applying the curing type adhesive composition for polarizing film to a surface of at least one of the polarizer and the transparent protective film,
a bonding step of causing the polarizer and the transparent protective film to bond to each other, and
an adhering step of radiating an active energy ray to the resultant bonded body from the polarizer surface side thereof, or the transparent protective film surface side thereof to cure the active energy ray curing type adhesive composition, and thereby adhering, through the resultant adhesive layer, the polarizer and the transparent protective film to each other.

25. An optical film, on which one or more polarizing films as recited in claim 20 are laminated.

26. An image display device, wherein the following is used: the polarizing film recited in claim 20.
